(19) United States
(12) Patent Application Publication
(10) Pub. No.: US 2026/0022714 A1
(43) Pub. Date: Jan. 22, 2026

(54) HYDRAULIC SYSTEM AND WORKING MACHINE

(71) Applicant: Kubota Corporation, Osaka (JP)

(72) Inventors: Yuta KATAYAMA, Sakai-shi (JP); Kohei NAGAO, Sakai-shi (JP); Tomoyuki NOGUCHI, Sakai-shi (JP)

(21) Appl. No.: 19/188,756

(22) Filed: Apr. 24, 2025

(30) Foreign Application Priority Data
Jul. 18, 2024 (JP) 2024-114454

(51) Int. Cl. F15B 13/04; F15B 15/18; F15B 19/00

(52) U.S. Cl. CPC F15B 13/0401; F15B 15/18; F15B 19/00; F15B 2211/6651

(57) ABSTRACT

A hydraulic system includes a control valve to adjust a flow rate and a pressure of hydraulic fluid supplied to a hydraulic actuator to actuate an attachment attached to a working machine, and a controller configured or programmed to control an opening of the control valve by changing an input current value input to the control valve. The controller is configured or programmed to, in activating or stopping the attachment by changing the input current value to a target current value corresponding to a target opening of the control valve, gradually change the input current value in a ramp manner while the input current value is within a first current range in which the attachment is actuated.

### CROSS REFERENCE TO RELATED APPLICATIONS

This application claims the benefit of priority to Japanese Patent Application No. 2024-114454 filed on Jul. 18, 2024. The entire contents of this application are hereby incorporated herein by reference.

### BACKGROUND OF THE INVENTION

### 1. Field of the Invention

The present invention relates to working machines and hydraulic systems to activate or stop attachments attached to the working machines.

### 2. Description of the Related Art

A working machine such as a skid-steer loader or a compact track loader performs work by a working device provided on the working machine and an attachment attached to the working device while the working machine is traveling or stopped. Thus, the working machine includes a hydraulic system as disclosed in, for example, Japanese Unexamined Patent Application Publication No. 2019-65999. The hydraulic system includes a control valve that adjusts the flow rate and the pressure of a hydraulic fluid that is supplied to a hydraulic actuator that causes the attachment to operate, a controller that controls the opening of the control valve by changing a current value that is input to the control valve including, for example, a solenoid proportional valve, and the like. The hydraulic actuator and the attachment are activated when the control valve is opened and the hydraulic fluid is supplied to the hydraulic actuator via the control valve. Also, the hydraulic actuator and the attachment stop when the control valve is closed and the hydraulic fluid is no longer supplied to the hydraulic actuator.

### SUMMARY OF THE INVENTION

At the time of activating or stopping the attachment, when the hydraulic fluid suddenly flows into the hydraulic actuator or suddenly stops flowing into the hydraulic actuator, the attachment suddenly operates or stops, and there is a concern that a large impact (vibration) is applied to the attachment. As a countermeasure, it is conceivable to control the opening of the control valve so that the hydraulic fluid gradually flows into the hydraulic actuator or gradually stops flowing into the hydraulic actuator. However, in this case, there is a concern that the time until the attachment activates or stops is delayed and the responsiveness is deteriorated.

Example embodiments of the present invention make it possible to prevent or reduce the occurrence of an impact and a deterioration in responsiveness in activating or stopping an attachment attached to a working machine.

A hydraulic system according to an example embodiment of the present invention includes a control valve to adjust a flow rate and a pressure of hydraulic fluid supplied to a hydraulic actuator to actuate an attachment attached to a working machine, and a controller configured or programmed to control an opening of the control valve by changing an input current value input to the control valve, wherein the controller is configured or programmed to, in activating or stopping the attachment by changing the input current value to a target current value corresponding to a target opening of the control valve, gradually change the input current value in a ramp manner in a first current range in which the attachment is actuated. A working machine according to an example embodiment of the present invention includes a linkage to link an attachment thereto, and the hydraulic system.

In an example embodiment of the present invention, the controller may be configured or programmed to, in activating the attachment, quickly increase the input current value in a step manner to a first current value within a second current range in which the attachment is not actuated, and gradually increase the input current value in a ramp manner from the first current value to a second current value which is the target current value.

In an example embodiment of the present invention, the hydraulic system may further include a first input interface to receive input of an instruction relating to actuation of the attachment. The controller may be configured or programmed to, when an instruction to activate the attachment is input via the first input interface, quickly increase the input current value in a step manner to the first current value and gradually increase the input current value in a ramp manner from the first current value to the second current value over a predetermined time period.

In an example embodiment of the present invention, the controller may be configured or programmed to determine the first current value which is a value lower by a first predetermined value than a maximum value of the second current range.

In an example embodiment of the present invention, the controller may be configured or programmed to determine the first current value which is a value higher than the target current value for use in stopping the attachment.

In an example embodiment of the present invention, the hydraulic system may further include a second input interface to receive input of attachment information relating to the attachment attached to the working machine. The controller may be configured or programmed to determine the first current value based on the attachment information input via the second input interface.

In an example embodiment of the present invention, the controller may be configured or programmed to determine the second current value based on the attachment information input via the second input interface.

In an example embodiment of the present invention, the hydraulic system may further include a manual operator including an operation actuator to be operated to set the flow rate and the pressure of hydraulic fluid supplied to the hydraulic actuator. The controller may be configured or programmed to, in activating the attachment, detect an operation amount of the operation actuator based on an operation signal output from the manual operator in accordance with an operation of the operation actuator, and determine the second current value based on the operation amount.

In an example embodiment of the present invention, the controller may be configured or programmed to, in stopping the attachment, gradually reduce the input current value in a ramp manner to a third current value within a second current range in which the attachment is not actuated, and quickly reduce the input current value in a step manner from the third current value to a fourth current value which is the target current value.

In an example embodiment of the present invention, the hydraulic system may further include a first input interface to receive input of an instruction relating to actuation of the attachment. The controller may be configured or programmed to, when an instruction to stop the attachment is input via the first input interface, gradually reduce the input current value in a ramp manner to the third current value over a predetermined time period and quickly reduce the input current value in a step manner from the third current value to the fourth current value.

In an example embodiment of the present invention, the controller may be configured or programmed to determine the third current value which is a value lower by a second predetermined value than a maximum value of the second current range.

In an example embodiment of the present invention, the hydraulic system may further include a second input interface to receive input of attachment information relating to the attachment attached to the working machine. The controller may be configured or programmed to determine the third current value based on the attachment information input via the second input interface.

In an example embodiment of the present invention, the hydraulic system may further include a manual operator including an operation actuator to be operated to set the flow rate and the pressure of hydraulic fluid supplied to the hydraulic actuator. The controller may be configured or programmed to, in driving the attachment which has been activated, detect an operation amount of the operation actuator based on an operation signal output from the manual operator in accordance with an operation of the operation actuator, determine a drive current value based on the operation amount, and input the drive current value into the control valve, and, in stopping the attachment, gradually reduce the input current value in a ramp manner from the drive current value to the third current value.

In an example embodiment of the present invention, the hydraulic system may further include a second input interface to receive input of attachment information relating to the attachment attached to the working machine. The controller may be configured or programmed to change at least one of (i) a change time taken for the input current value to reach the target current value or (ii) an amount of current change per unit time when the input current value gradually changes in a ramp manner, based on the attachment information input via the second input interface.

In an example embodiment of the present invention, the controller may be configured or programmed to determine a type of the hydraulic actuator based on the attachment information input via the second input interface, and change at least one of the change time or the amount of current change per unit time based on the type of the hydraulic actuator.

In an example embodiment of the present invention, the controller may be configured or programmed to, in a case that the hydraulic actuator is a linear motion hydraulic actuator, perform at least one of (i) reducing the change time compared to a case where the hydraulic actuator is a rotary motion hydraulic actuator or (ii) increasing the amount of current change per unit time as compared to the case where the hydraulic actuator is a rotary motion hydraulic actuator.

In an example embodiment of the present invention, the hydraulic system may further include a prime mover, a hydraulic pump to deliver hydraulic fluid using power output from the prime mover, and a rotation speed detector to detect a rotation speed of the prime mover. The controller may be configured or programmed to, in activating or stopping the attachment, change the amount of current change per unit time when the input current value gradually changes in a ramp manner, in accordance with the rotation speed of the prime mover detected by the rotation speed detector.

In an example embodiment of the present invention, the controller may be configured or programmed to increase the amount of current change per unit time as the rotation speed of the prime mover decreases.

In an example embodiment of the present invention, the hydraulic system may further include a temperature detector to detect a temperature of hydraulic fluid. The controller may be configured or programmed to, in activating or stopping the attachment, change the amount of current change per unit time when the input current value gradually changes in a ramp manner, in accordance with the temperature of hydraulic fluid detected by the temperature detector.

In an example embodiment of the present invention, the controller may be configured or programmed to increase the amount of current change per unit time as the temperature of the hydraulic fluid decreases.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a diagram illustrating an example of a hydraulic circuit of a hydraulic system of a working machine.

FIG. 2 is a diagram illustrating an example of an electrical configuration of the hydraulic system of the working machine.

FIG. 3 is a table presenting an example of control data for attachments.

FIG. 4 is a graph presenting an example of a change in an input current value to an AUX solenoid control valve.

FIG. 5 is a flowchart presenting an example of attachment use processing.

FIG. 6 is a graph presenting another example of a change in the input current value to the AUX solenoid control valve.

FIG. 7 is a graph presenting another example of a change in the input current value to the AUX solenoid control valve.

FIG. 8 is a graph presenting another example of a change in the input current value to the AUX solenoid control valve.

FIG. 9 is a graph presenting the relationship between the rotation speed of a prime mover and the slope of a ramp function.

FIG. 10 is a graph presenting the relationship between the temperature of a hydraulic fluid of the working machine and the slope of a ramp function.

FIG. 11 is a side view of the working machine.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

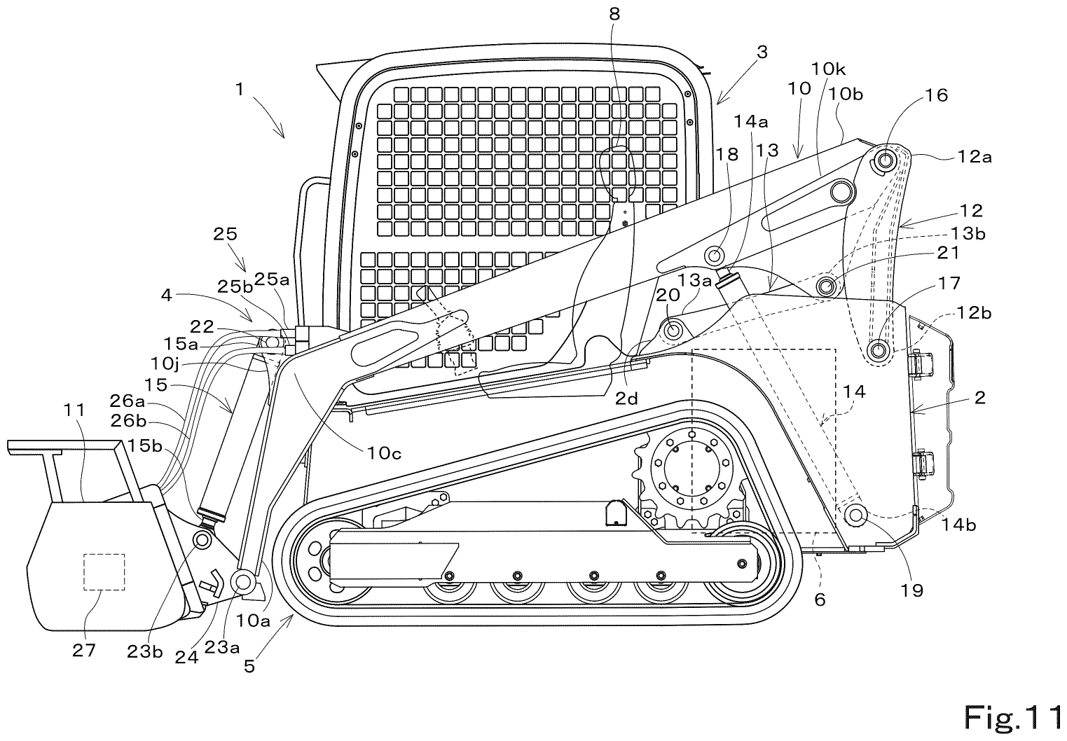

Hereinafter, example embodiments of the present invention will be described with reference to the drawings. FIG. 11 is a side view of a working machine 1 of an example embodiment of the present invention. In the present example embodiment, a compact track loader is illustrated as an example of the working machine 1. Working machines according to example embodiments of the present invention are not limited to the compact track loader, and may be another loader working machine such as a skid-steer loader, or a working machine other than the loader working machine.

The working machine 1 includes a machine body 2, a cabin 3, a working device 4, at least one traveling device 5, and a prime mover 6. The cabin 3 is mounted on an upper portion of the machine body 2. An operator's seat 8 is provided inside the cabin 3. The prime mover 6 is provided in a rear portion of the machine body 2. The prime mover 6 is a power source of the working machine 1. In the present example embodiment, the prime mover 6 is a diesel engine, but may be another internal combustion engine (engine) such as a gasoline engine, or may be a motor such as an electric motor.

The at least one traveling device 5 includes traveling devices 5 provided on the left and right of the machine body 2. That is, the traveling devices 5 are provided as a pair of left and right traveling devices 5. The pair of left and right traveling devices 5 support the machine body 2 so as to allow the machine body 2 to travel. In the present example embodiment, a crawler type traveling device is exemplified as the traveling device 5, but alternative to this, a wheeled type traveling device including a front wheel and a rear wheel may be used, or a semi-crawler type traveling device may be used.

The working device 4 extends forward of the machine body 2. The working device 4 includes at least one boom 10, at least one first link 12, at least one second link 13, at least one lift cylinder 14, and at least one tilt cylinder 15. The lift cylinder 14 and the tilt cylinder 15 are hydraulic cylinders (hydraulic actuators).

The at least one boom 10 includes booms 10 provided on the left and right of the cabin 3 so as to be swingable upward/downward. A front end portion 10a of the left boom 10 and a front end portion 10a of the right boom 10 are coupled to each other by a coupling pipe having an irregular shape. A rear end portion 10b of the left boom 10 and a rear end portion 10b of the right boom 10 are coupled to each other by a coupling pipe having a circular shape. The at least one first link 12 includes first links 12, the at least one second link 13 includes second links 13, the at least one lift cylinder 14 includes lift cylinders 14, and the at least one tilt cylinder 15 includes tilt cylinders 15 provided on the left and right of the machine body 2, respectively, in correspondence with the left boom 10 and the right boom 10. The first links 12 and the second links 13 support the rear end portions 10b of the booms 10 so as to be swingable upward/downward.

Specifically, the first links 12 are provided in a vertical direction at the rear end portions 10b of the booms 10. Upper end portions 12a of the first links 12 are pivotally supported at the rear end portions 10b of the booms 10 via a pivot 16 so as to be rotatable about a horizontal axis. The pivot 16 extends through rear portions of brackets 10k attached to rear portions of the booms 10. Lower end portions 12b of the first links 12 are pivotally supported at positions close to the rear of the machine body 2 via a pivot 17 so as to be rotatable about a horizontal axis. The pivot 17 is provided at a rear upper portion of the machine body 2.

The second links 13 are provided forward of the first links 12. Front end portions 13a of the second links 13 are pivotally supported by a pivot 20 so as to be rotatable about a horizontal axis. The pivot 20 is supported by brackets 2d fixed to the machine body 2. Rear end portions 13b of the second links 13 are pivotally supported by a pivot 21 so as to be rotatable about a horizontal axis. The pivot 21 is provided forward of the pivot 17 and higher than the pivot 17 and is supported by lower portions of the brackets 10k.

Upper end portions 14a of the lift cylinders 14 are pivotally supported by a pivot 18 so as to be rotatable about a horizontal axis. The pivot 18 is provided at central portions of the booms 10 and penetrates through front portions of the brackets 10k. Lower end portions 14b of the lift cylinders 14 are pivotally supported by a pivot 19 so as to be rotatable about a horizontal axis. The pivot 19 is provided at a rear lower portion of the machine body 2.

The booms 10 swing upward/downward about the pivot 16 by extension/retraction of the lift cylinders 14. That is, the front end portions 10a of the booms 10 are raised/lowered. The second links 13 swing upward/downward about the pivot 20 due to the upward/downward swing of the booms 10. The first links 12 swing forward/rearward about the pivot 17 due to the upward/downward swing of the second links 13. That is, the booms 10 are movable in the front-rear direction.

A hitch 24 is coupled to the front end portions 10a of the booms 10 (working device 4). The hitch 24 is a linkage that couples an attachment 11, and is included in the working machine 1. The front end portions 10a of the booms 10 are pivotally supported by a pivot 23a provided at a lower portion of the hitch 24 so as to be rotatable about a horizontal axis.

The tilt cylinders 15 are provided forward of the left and right booms 10, respectively. Upper end portions 15a of the tilt cylinders 15 are pivotally supported via a pivot 22 so as to be rotatable about a horizontal axis. The pivot 22 is provided at brackets 10j fixed to curved portions 10c of the booms 10. Lower end portions 15b of the tilt cylinders 15 are pivotally supported by a pivot 23b provided at an upper portion of the hitch 24 so as to be rotatable about a horizontal axis.

When the tilt cylinders 15 extend/retract, the hitch 24 swings about the pivot 23a, and the attachment 11 coupled to the hitch 24 swings upward/downward and forward/rearward. That is, the attachment 11 is swingably (tiltably) coupled to the front end portions 10a of the booms 10 via the hitch 24.

The attachment 11 is a working tool for performing work. The attachment 11 is attached to the working device 4 and the working machine 1 by being coupled to a front surface of the hitch 24. The attachment 11 is detached from the working device 4 and the working machine 1 by release (disengagement) of the coupling between the attachment 11 and the hitch 24. That is, the attachment 11 is attachable to and detachable from the hitch 24, the working device 4, and the working machine 1.

FIG. 11 illustrates a state in which a mulcher (fallen tree crusher) is attached as the attachment 11 to the working device 4 and the working machine 1 via the hitch 24. An attachment 11 other than the mulcher is also attachable to the working device 4 and the working machine I via the hitch 24. Examples of the attachable attachment 11 include a crusher, a breaker, a grapple, an angle broom, an earth auger, a pallet fork, a sweeper, a mower, a snow blower, and the like. A hydraulic actuator 27 that causes the attachment 11 to operate is mounted on the attachment 11. Examples of the hydraulic actuator 27 include a linear motion hydraulic actuator such as a hydraulic cylinder and a rotary motion hydraulic actuator such as a hydraulic motor.

In the working machine 1, not only the attachment 11 as described above but also an attachment such as a bucket on which the hydraulic actuator 27 is not mounted can be used. After the attachment on which the hydraulic actuator 27 is not mounted is attached to the front end portions 10a of the booms 10 via the hitch 24, when the booms 10 are raised/lowered by the lift cylinders 14 and the attachment is swung by the tilt cylinders 15, predetermined work (excavation work or the like) can be performed.

The hydraulic actuator 27 mounted on the attachment 11 is driven by a hydraulic fluid that is supplied from the working machine 1. The machine body 2 of the working machine 1 is provided with an AUX coupler 25. The AUX coupler 25 is an AUX port through which the hydraulic fluid flows into and out of the hydraulic actuator 27. The AUX coupler 25 includes a first AUX coupler 25a and a second AUX coupler 25b.

As illustrated in FIG. 11, a worker connects an external fluid passage 26a including a hose or the like to the first AUX coupler 25a and a first coupler provided at the attachment 11, and connects an external fluid passage 26b to a second coupler provided at the attachment 11 and the second AUX coupler 25b. Accordingly, the hydraulic fluid can be supplied from the working machine 1 to the hydraulic actuator 27 of the attachment 11, and the hydraulic fluid can be returned from the hydraulic actuator 27 to the working machine 1. A hydraulic circuit is located between the working machine 1 and the hydraulic actuator 27, the hydraulic actuator 27 is driven by the hydraulic fluid from the working machine 1, and the attachment 11 is also driven. Accordingly, predetermined work can be performed by the attachment 11.

When at least one of the hydraulic actuators 14 and 15 included in the working device 4 is driven by the hydraulic fluid, the posture (height, inclination, tilt angle, and/or the like) of the attachment 11 is changed. Also, when at least one of the hydraulic actuators 14 and 15 and the hydraulic actuator 27 provided in the attachment 11 is driven, at least one of the working device 4 and the attachment 11 operates to perform work. The work performed by the working device 4 and the attachment 11 is performed when the working machine 1 is traveling using the traveling devices 5 or when the traveling is stopped.

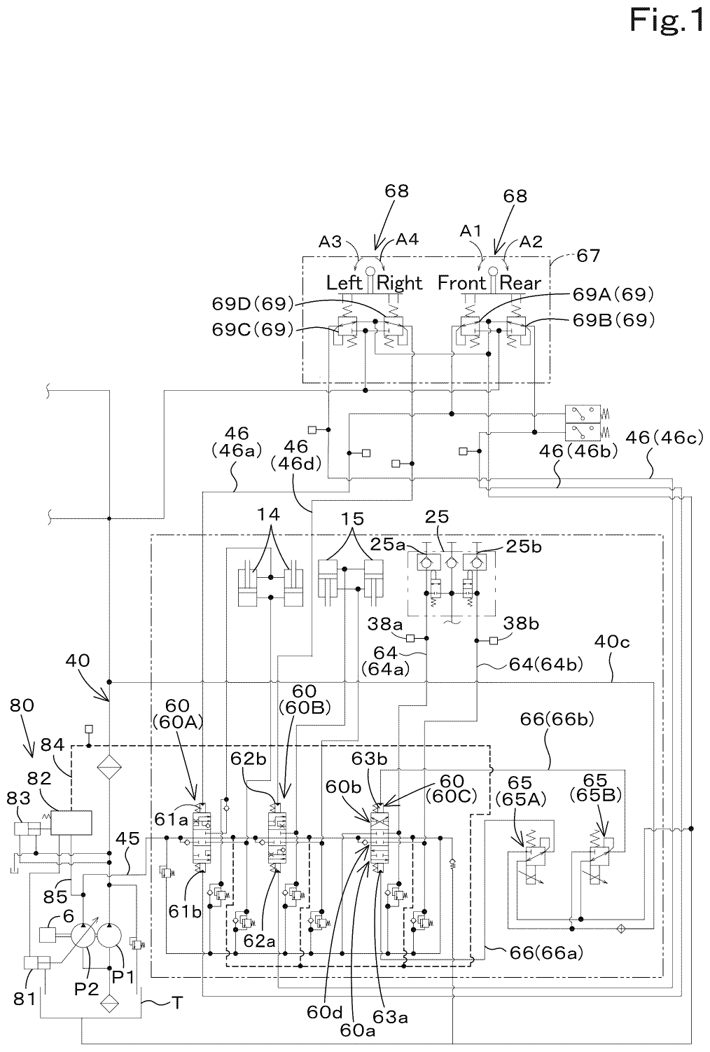

FIG. 1 is a diagram illustrating an example of a hydraulic circuit of a hydraulic system 100 mounted on the working machine 1. The hydraulic circuit of FIG. 1 is a hydraulic circuit of a working system. The hydraulic system 100 includes a pilot pump P1 and a main pump P2. For example, the pilot pump P1 is a fixed displacement type hydraulic pump, and the main pump P2 is a variable displacement type hydraulic pump. The pilot pump P1 is actuated by power of the prime mover 6 to deliver a hydraulic fluid stored in a hydraulic fluid tank T to a delivery fluid passage 40. The hydraulic fluid delivered by the pilot pump P1 is a pilot fluid used to control various hydraulic devices included in the working machine 1.

The main pump P2 is actuated by the power of the prime mover 6 to deliver the hydraulic fluid stored in the hydraulic fluid tank T to a main fluid passage 45. The hydraulic fluid delivered from the main pump P2 is used to actuate the lift cylinders 14 and the tilt cylinders 15 provided on the working device 4, and the hydraulic actuator 27 of the attachment 11.

The hydraulic system 100 includes a plurality of control valves 60. The plurality of control valves 60 include a lift control valve 60A, a tilt control valve 60B, and an AUX control valve 60C. The plurality of control valves 60 can control the actuation of the hydraulic actuators 14, 15, and 27, respectively. Each of the plurality of control valves 60 is connected to the main fluid passage 45. The plurality of control valves 60 each switch the flow rate (output) and the supply direction of the hydraulic fluid that is supplied from the main fluid passage 45 to the corresponding hydraulic actuator 14, 15, or 27 to control driving of the corresponding hydraulic actuator 14, 15, or 27.

The lift control valve 60A is connected to the lift cylinders 14 that raise/lower the booms 10 by a plurality of fluid passages. The lift control valve 60A is a pilot-type direct-acting spool-form three-position switching valve. The lift control valve 60A includes a plurality of working pressure receivers 61a and 61b, and is switched to a third position (neutral position), a first position, and a second position in accordance with a pilot pressure acting on the working pressure receiver 61a or 61b. When the lift control valve 60A is in the third position, the hydraulic fluid is not supplied from the main fluid passage 45 to the lift cylinders 14.

When the lift control valve 60A is switched to one of the first position and the second position, the hydraulic fluid is supplied from the main fluid passage 45 to the lift cylinders 14, and the supply direction of the hydraulic fluid is switched. Also, when the lift control valve 60A is in one of the first position and the second position, the opening of the lift control valve 60A changes in accordance with the pilot pressure, which is the pressure of the pilot fluid. Therefore, the flow rate of the hydraulic fluid that is supplied from the main fluid passage 45 to the lift cylinders 14 is changed. In this way, the lift control valve 60A controls the flow rate and the supply direction of the hydraulic fluid that is supplied to the lift cylinders 14 to extend/retract the lift cylinders 14.

The tilt control valve 60B is connected to the tilt cylinders 15 that swing the attachment 11 by a plurality of fluid passages. The tilt control valve 60B is a pilot-type direct-acting spool-form three-position switching valve. The tilt control valve 60B includes a plurality of working pressure receivers 62a and 62b, and is switched to a third position (neutral position), a first position, and a second position in accordance with a pilot pressure acting on the working pressure receiver 62a or 62b. When the tilt control valve 60B is in the third position, the hydraulic fluid is not supplied from the main fluid passage 45 to the tilt cylinders 15.

When the tilt control valve 60B is switched to one of the first position and the second position, the hydraulic fluid is supplied from the main fluid passage 45 to the tilt cylinders 15, and the supply direction of the hydraulic fluid is switched. Also, when the tilt control valve 60B is in one of the first position and the second position, the opening of the tilt control valve 60B changes in accordance with the pilot pressure. Therefore, the flow rate of the hydraulic fluid that is supplied from the main fluid passage 45 to the tilt cylinders 15 is changed. In this way, the tilt control valve 60B controls the flow rate and the supply direction of the hydraulic fluid that is supplied from the main fluid passage 45 to the tilt cylinders 15 to extend/retract the tilt cylinders 15.

The AUX control valve 60C is connected to the AUX coupler 25 by a plurality of fluid passages 64. Specifically, a first port of the AUX control valve 60C and the first AUX coupler 25a are connected to each other via a fluid passage 64a, and a second port of the AUX control valve 60C and the second AUX coupler 25b are connected to each other via a fluid passage 64b. The AUX control valve 60C is a pilot-type direct-acting spool-form three-position switching valve. The AUX control valve 60C includes a plurality of AUX pressure receivers 63a and 63b, and is switched to a third position (neutral position) 60d, a first position 60a different from the third position 60d, and a second position 60b different from the third position 60d and the first position 60a, in accordance with a pilot pressure acting on the AUX pressure receiver 63a or 63b.

When the AUX control valve 60C is in the third position 60d, the hydraulic fluid is not supplied from the main fluid passage 45 to the hydraulic actuator 27 of the attachment 11 via the fluid passage 64 and the AUX coupler 25. When the AUX control valve 60C is switched to one of the first position 60a and the second position 60b, the hydraulic fluid is supplied from the main fluid passage 45 to the hydraulic actuator 27 via the fluid passage 64 and the AUX coupler 25, and the supply direction of the hydraulic fluid is switched.

Specifically, when the AUX control valve 60C is switched to the first position 60a, the hydraulic fluid flowing from the main fluid passage 45 to the AUX control valve 60C is supplied to the hydraulic actuator 27 via the fluid passage 64a, the first AUX coupler 25a, and the like, and the hydraulic fluid discharged from the hydraulic actuator 27 returns to the AUX control valve 60C via the second AUX coupler 25b and the fluid passage 64b and is discharged from the AUX control valve 60C. Also, when the AUX control valve 60C is switched to the second position 60b, the hydraulic fluid flowing from the main fluid passage 45 to the AUX control valve 60C is supplied to the hydraulic actuator 27 via the fluid passage 64b and the second AUX coupler 25b, and the hydraulic fluid discharged from the hydraulic actuator 27 returns to the AUX control valve 60C via the first AUX coupler 25a and the fluid passage 64a and is discharged from the AUX control valve 60C.

Also, when the AUX control valve 60C is in one of the first position 60a and the second position 60b, the opening of the AUX control valve 60C changes in accordance with the pilot pressure. Therefore, the flow rate and the pressure of the hydraulic fluid that is supplied from the main fluid passage 45 to the hydraulic actuator 27 via the AUX coupler 25 are changed. In this way, the AUX control valve 60C controls the supply direction, the flow rate, and the pressure of the hydraulic fluid that is supplied from the main fluid passage 45 to the hydraulic actuator 27 via the fluid passage 64 and the AUX coupler 25 in accordance with the pilot pressure acting on the AUX pressure receiver 63a or 63b, to actuate the hydraulic actuator 27.

The hydraulic system 100 includes a plurality of AUX solenoid control valves 65 that change the position and the opening of the AUX control valve 60C to adjust the flow rate and the pressure of the hydraulic fluid that is supplied to the hydraulic actuator 27. Each of the plurality of AUX solenoid control valves 65 is a solenoid proportional valve in which a solenoid is energized and the opening changes in accordance with an input current value (control signal). Also, each of the plurality of AUX solenoid control valves 65 is provided in a branch fluid passage 40c branched from the delivery fluid passage 40. Changing the opening of the AUX solenoid control valve 65 changes the pilot pressure of the pilot fluid supplied from the delivery fluid passage 40. As the current value input to each of the plurality of AUX solenoid control valves 65 increases, the opening of each of the plurality of AUX solenoid control valves 65 increases, and the pilot pressure output from each of the plurality of AUX solenoid control valves 65 increases.

The plurality of AUX solenoid control valves 65 include a first AUX solenoid control valve 65A and a second AUX solenoid control valve 65B. The first AUX solenoid control valve 65A and the second AUX solenoid control valve 65B are connected to the AUX pressure receivers 63a and 63b of the AUX control valve 60C, respectively, by a control fluid passage 66. Specifically, the control fluid passage 66 includes a first control fluid passage 66a that connects the first AUX solenoid control valve 65A and the AUX pressure receiver 63a of the AUX control valve 60C to each other, and a second control fluid passage 66b that connects the second AUX solenoid control valve 65B and the AUX pressure receiver 63b of the AUX control valve 60C to each other.

When the opening of the first AUX solenoid control valve 65A becomes larger than 0% (zero percent), the pilot fluid from the delivery fluid passage 40 acts on the AUX pressure receiver 63a of the AUX control valve 60C via the first AUX solenoid control valve 65A and the first control fluid passage 66a. Also, at this time, the pilot pressure corresponding to the opening of the first AUX solenoid control valve 65A acts on the AUX pressure receiver 63a. When the pilot pressure acting on the AUX pressure receiver 63a becomes a predetermined value or more, the spool included in the AUX control valve 60C moves, the AUX control valve 60C switches from the third position 60d to the first position 60a, and the hydraulic fluid can be supplied from the AUX control valve 60C to the hydraulic actuator 27 via the fluid passage 64a and the first AUX coupler 25a.

Also, when the opening of the first AUX solenoid control valve 65A changes and the pilot pressure acting on the AUX pressure receiver 63a changes, the opening of the first position 60a of the AUX control valve 60C also changes. When the opening of the first position 60a changes, the flow rate and the pressure of the hydraulic fluid that is supplied from the AUX control valve 60C to the hydraulic actuator 27 via the fluid passage 64a and the first AUX coupler 25a change.

When the opening of the second AUX solenoid control valve 65B becomes larger than 0% (zero percent), the pilot fluid from the delivery fluid passage 40 acts on the AUX pressure receiver 63b of the AUX control valve 60C via the second AUX solenoid control valve 65B and the second control fluid passage 66b. Also, at this time, the pilot pressure corresponding to the opening of the second AUX solenoid control valve 65B acts on the AUX pressure receiver 63b. When the pilot pressure acting on the AUX pressure receiver 63b becomes a predetermined value or more, the spool of the AUX control valve 60C moves, the AUX control valve 60C switches from the third position 60d to the second position 60b, and the hydraulic fluid can be supplied from the AUX control valve 60C to the hydraulic actuator 27 via the fluid passage 64b and the second AUX coupler 25b.

Also, when the opening of the second AUX solenoid control valve 65B changes and the pilot pressure acting on the AUX pressure receiver 63b changes, the opening of the second position 60b of the AUX control valve 60C also changes. When the opening of the second position 60b changes, the flow rate and the pressure of the hydraulic fluid that is supplied from the AUX control valve 60C to the hydraulic actuator 27 via the fluid passage 64b and the second AUX coupler 25b change.

As described above, the first AUX solenoid control valve 65A and the second AUX solenoid control valve 65B change the pilot pressures acting on the AUX pressure receivers 63a and 63b of the AUX control valve 60C in accordance with the input current values, respectively. Therefore, the flow rate and the pressure of the hydraulic fluid from the AUX control valve 60C to the hydraulic actuator 27 are changed.

The working machine 1 includes a working manual operator 67. The working manual operator 67 operates the lift cylinders 14 and the tilt cylinders 15 of the working device 4. The working manual operator 67 changes the pilot pressures acting on the working pressure receivers 61a, 61b, 62a, and 62b of the lift control valve 60A and the tilt control valve 60B, respectively. Therefore, the flow rate and the supply direction of the hydraulic fluid that is supplied to the lift cylinders 14 and the tilt cylinders 15 are switched. The working manual operator 67 includes a working operation actuator 68 and a plurality of working operation valves 69.

The working operation actuator 68 can be operated to swing in at least four directions with reference to a neutral position. The plurality of working operation valves 69 are actuated in accordance with an operation of the working operation actuator 68. The plurality of working operation valves 69 are connected to the delivery fluid passage 40 and change the pilot pressure of the pilot fluid supplied from the delivery fluid passage 40. The plurality of working operation valves 69 are a first pilot valve 69A, a second pilot valve 69B, a third pilot valve 69C, and a fourth pilot valve 69D.

The plurality of working operation valves 69 are connected to the plurality of control valves 60 by working fluid passages 46 (46a to 46d). Among these, the first working fluid passage 46a is a fluid passage that connects the first pilot valve 69A and the working pressure receiver 61a of the lift control valve 60A to each other. The second working fluid passage 46b is a fluid passage that connects the second pilot valve 69B and the working pressure receiver 61b of the lift control valve 60A to each other. The third working fluid passage 46c is a fluid passage that connects the third pilot valve 69C and the working pressure receiver 62a of the tilt control valve 60B to each other. The fourth working fluid passage 46d is a fluid passage that connects the fourth pilot valve 69D and the working pressure receiver 62b of the tilt control valve 60B to each other.

When the working operation actuator 68 is swung forward (A1 direction), the pilot fluid is supplied from the first pilot valve 69A to the first working fluid passage 46a, and the pilot pressure of the pilot fluid acts on the working pressure receiver 61a of the lift control valve 60A via the first working fluid passage 46a. Accordingly, the lift control valve 60A changes the flow rate and the supply direction of the hydraulic fluid that is supplied to the lift cylinders 14. Therefore, the lift cylinders 14 retract, and the booms 10 are lowered.

When the working operation actuator 68 is swung rearward (A2 direction), the pilot fluid is supplied from the second pilot valve 69B to the second working fluid passage 46b, and the pilot pressure of the pilot fluid acts on the working pressure receiver 61b of the lift control valve 60A via the second working fluid passage 46b. Accordingly, the lift control valve 60A changes the flow rate and the supply direction of the hydraulic fluid that is supplied to the lift cylinders 14. Therefore, the lift cylinders 14 extend, and the booms 10 are raised.

When the working operation actuator 68 is swung leftward (A3 direction), the pilot fluid is supplied from the third pilot valve 69C to the third working fluid passage 46c, and the pilot pressure of the pilot fluid acts on the working pressure receiver 62a of the tilt control valve 60B via the third working fluid passage 46c. Accordingly, the tilt control valve 60B changes the flow rate and the supply direction of the hydraulic fluid that is supplied to the tilt cylinders 15. Therefore, the tilt cylinders 15 retract, and the attachment 11 swings upward.

When the working operation actuator 68 is swung rightward (A4 direction), the pilot fluid is supplied from the fourth pilot valve 69D to the fourth working fluid passage 46d, and the pilot pressure of the pilot fluid acts on the working pressure receiver 62b of the tilt control valve 60B via the fourth working fluid passage 46d. Accordingly, the tilt control valve 60B changes the flow rate and the supply direction of the hydraulic fluid that is supplied to the tilt cylinders 15. Therefore, the tilt cylinders 15 extend, and the attachment 11 swings downward.

The hydraulic system 100 includes a load sensing system (LS system) 80. The LS system 80 controls the flow rate of the hydraulic fluid that is delivered by the main pump P2 so that the differential pressure obtained by subtracting the maximum load pressure among load pressures of the plurality of hydraulic actuators 14, 15, and 27 actuated by the hydraulic fluid delivered by the main pump P2, from the delivery pressure of the hydraulic fluid by the variable displacement type main pump P2 becomes a constant pressure.

The LS system 80 includes a swash plate change cylinder 81, a flow rate compensation valve 82, and an opening change cylinder 83. The swash plate change cylinder 81 adjusts the angle of a swash plate included in the main pump P2. The flow rate compensation valve 82 causes the hydraulic pressure to act on the swash plate change cylinder 81 to actuate the swash plate change cylinder 81. The opening change cylinder 83 is actuated by the pilot pressure of the pilot fluid from the pilot pump P1 to change the opening of the flow rate compensation valve 82.

A PLS fluid passage 84 and a PPS fluid passage 85 are connected to the flow rate compensation valve 82. The PLS fluid passage 84 is a fluid passage that transmits a PLS pressure that is the maximum load pressure (actuator maximum load pressure) among the load pressures of the plurality of hydraulic actuators 14, 15, and 27. The PPS fluid passage 85 is a fluid passage that transmits a PPS pressure that is the delivery pressure of the main pump P2. The flow rate compensation valve 82 actuates the swash plate change cylinder 81 to adjust the angle of the swash plate of the main pump P2 so that the differential pressure obtained by subtracting the PLS pressure from the PPS pressure becomes a constant pressure. Accordingly, the delivery amount of the hydraulic fluid by the main pump P2 is controlled, and the hydraulic pressure (power) corresponding to the load that is applied to the working device 4 and the attachment 11 is output from the main pump P2.

The swash plate of the main pump P2 is configured to be pressed in a direction in which the delivery amount of the hydraulic fluid of the main pump P2 is increased by the self-pressure of the main pump P2. Also, the swash plate change cylinder 81 is configured to cause a force that counteracts the self-pressure of the main pump P2 to act on the swash plate. Further, the flow rate compensation valve 82 is configured to control the delivery amount of the main pump P2 by adjusting the hydraulic pressure acting on the swash plate change cylinder 81. Thus, when the hydraulic pressure acting on the swash plate change cylinder 81 is released (becomes zero), the angle of the swash plate of the main pump P2 becomes the maximum angle, and the flow rate of the hydraulic fluid delivered from the main pump P2 becomes the maximum flow rate.

The hydraulic system 100 also includes a traveling hydraulic circuit to cause the working machine 1 to travel, in addition to the working hydraulic circuit illustrated in FIG. 1. The traveling hydraulic circuit includes a plurality of traveling pumps, a plurality of traveling motors, and a traveling manual operator. The plurality of traveling pumps and the plurality of traveling motors are provided so as to correspond to the first traveling device 5 and the second traveling device 5. The plurality of traveling pumps are driven by the power of the prime mover 6. The plurality of traveling motors each are rotationally driven by the hydraulic fluid delivered from the corresponding traveling pump. When the plurality of traveling motors are rotationally driven, the first traveling device 5 and the second traveling device 5 are driven, and the working machine I travels. The plurality of traveling pumps, the plurality of traveling motors, and the plurality of traveling devices 5 are operated by the traveling manual operator. Specifically, when an operator operates a traveling operation actuator included in the traveling manual operator, the delivery directions of the hydraulic fluid from the plurality of traveling pumps are changed, the rotation directions of the plurality of traveling motors are changed, and the rotation directions of the plurality of traveling devices 5 are also changed. Therefore, the working machine 1 travels forward/rearward and turns rightward/leftward.

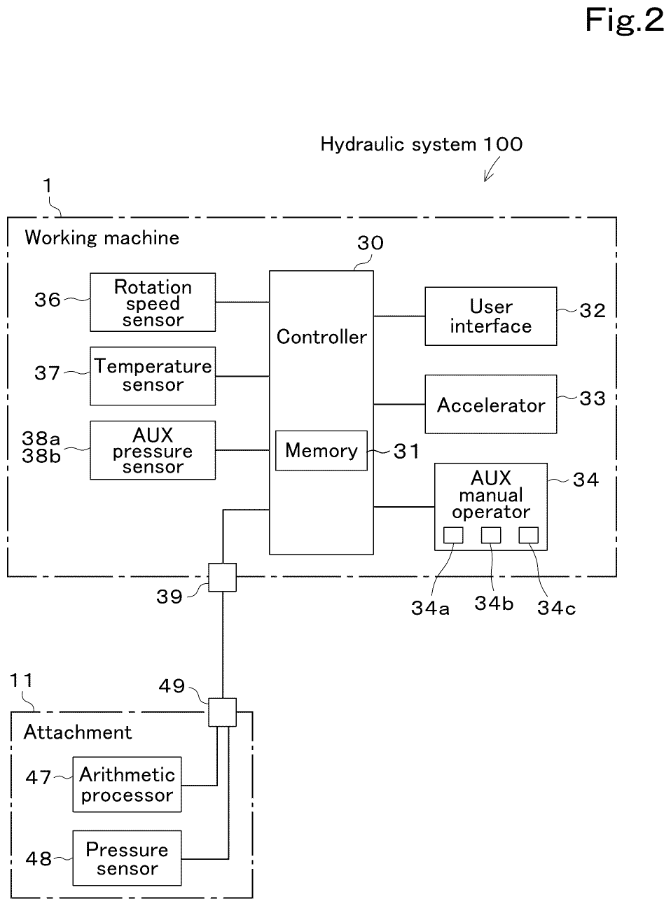

FIG. 2 is a diagram illustrating an example of an electrical configuration of the hydraulic system 100 of the working machine 1. The working machine 1 and the hydraulic system 100 include a controller 30, a memory 31, a user interface 32, an accelerator 33, an AUX manual operator 34, a rotation speed sensor 36, a temperature sensor 37, AUX pressure sensors 38a and 38b, and an AUX connector 39.

The controller 30 includes a processor such as a CPU, the memory 31, and the like. The controller 30 is a controller of the working machine 1 and the hydraulic system 100. The memory 31 is a volatile or nonvolatile memory. The memory 31 is a storage of the working machine 1 and the hydraulic system 100. The memory 31 stores a software program and data for the controller 30 to control each component of the working machine 1 and the hydraulic system 100. Also, data for controlling each component of the working machine 1 and the hydraulic system 100 is stored in the memory 31 by the controller 30. As another example, a memory (storage) separate from the controller 30 may be provided in the working machine 1 and the hydraulic system 100.

The user interface 32 is, for example, a touch panel, a tablet type terminal device, or the like, and includes a display that displays information. The controller 30 is configured or programmed to display (output) various kinds of information relating to the working machine 1 stored in an internal memory or the memory 31 to a user such as the operator of the working machine 1 through the user interface 32. Also, the user can input various kinds of information and instructions to the controller 30 (working machine 1) by operating the user interface 32. The controller 30 is configured or programmed to store the information input through the user interface 32 in the memory 31.

The user can input attachment information that is information relating to the attachment 11 attached to the working machine 1 through the user interface 32. For example, the controller 30 is configured or programmed to read data for a plurality of icons respectively indicating a plurality of attachments 11 attachable to the working machine 1 from the memory 31, and causes a predetermined input screen to display the plurality of icons through the user interface 32. The controller 30 is configured or programmed to, when the user performs an operation of selecting an icon indicating the attachment 11 attached to the working machine 1 from the plurality of displayed icons through the user interface 32, receive the selected icon as attachment information, read other identification information (name, model number, ID, and/or the like) on the attachment 11 corresponding to the attachment information from the memory 31, and also handle the read identification information as attachment information.

As another example, a configuration in which the user manually inputs identification information such as the name and the model number of the attachment 11 attached to the working machine 1 as attachment information via the user interface 32 may be used. Also, the controller 30 may read other information relating to the attachment 11 corresponding to the identification information from the memory 31 based on the identification information on the attachment 11 input through the user interface 32, and may handle the read information and the input identification information as attachment information. The user interface 32 is an output device (output interface) and is also an input interface (input device) of the working machine 1 and the hydraulic system 100. Also, the user interface 32 is an example of an input interface (second input interface) to input attachment information.

The accelerator 33 and the AUX manual operator 34 are installed in the vicinity of the operator's seat 8 in the cabin 3 and are operated by the operator of the working machine 1. The accelerator 33 inputs a target rotation speed of the prime mover (engine) 6, and includes an accelerator operation actuator and an accelerator sensor. The accelerator operation actuator is, for example, an operation actuator such as a lever, a pedal, a dial, or a slider. The accelerator sensor outputs a signal corresponding to an operation position of the accelerator operation actuator. The controller 30 is configured or programmed to determine the target rotation speed of the prime mover 6 based on an accelerator signal output from the accelerator sensor of the accelerator 33. That is, the accelerator 33 inputs a signal corresponding to the target rotation speed of the prime mover 6 to the controller 30.

The AUX manual operator 34 includes an AUX mode switch 34a, an AUX operation switch 34b, and an AUX volume switch 34c. The AUX manual operator 34 is an example of an input interface (input device, first input interface) to input an operation instruction for the attachment 11.

The AUX mode switch 34a is an operation switch that is operated to turn on an AUX mode in which the hydraulic fluid is supplied from the working machine 1 to the hydraulic actuator 27 mounted on the attachment 11. When the operator performs a turn-on operation on the AUX mode switch 34a, an operation signal (electric signal) corresponding to the turn-on operation is input from the AUX manual operator 34 to the controller 30, and the controller 30 (working machine 1) that has received the operation signal shifts to the AUX mode.

The AUX operation switch 34b is an operation switch that is operated to input an operation instruction for the attachment 11 on which the hydraulic actuator 27 is mounted. When the operator performs a predetermined activation operation on the AUX operation switch 34b, an operation signal (electric signal) indicating an activation instruction for the attachment 11 is input from the AUX manual operator 34 to the controller 30. Also, when the operator performs a predetermined stop operation on the AUX operation switch 34b, an operation signal (electric signal) indicating a stop instruction for the attachment 11 is input from the AUX manual operator 34 to the controller 30.

The controller 30 is configured or programmed to, when the activation instruction for the attachment 11 is input from the AUX manual operator 34, change the input current value that is input to the AUX solenoid control valve 65A or 65B to control the opening of the AUX solenoid control valve 65A or 65B, and open one of the AUX solenoid control valves 65A and 65B. Accordingly, the pilot pressure acting on the AUX control valve 60C from the AUX solenoid control valve 65A or 65B changes, the AUX control valve 60C switches to the first position 60a or the second position 60b, the hydraulic fluid is supplied to the hydraulic actuator 27 of the attachment 11 via the AUX control valve 60C and the AUX coupler 25, and the hydraulic actuator 27 and the attachment 11 are activated.

Also, the controller 30 is configured or programmed to, when the stop instruction for the attachment 11 is input from the AUX manual operator 34, change the input current value that is input to the AUX solenoid control valve 65A or 65B to control the opening of the AUX solenoid control valve 65A or 65B, and close the AUX solenoid control valve 65A or 65B. Accordingly, the pilot pressure acting on the AUX control valve 60C from the AUX solenoid control valve 65A or 65B changes, the AUX control valve 60C switches to the third position (neutral position) 60d, the hydraulic fluid is no longer supplied to the hydraulic actuator 27, and the hydraulic actuator 27 and the attachment 11 stop.

The AUX volume switch 34c is an operation switch (operation actuator) operated to set and adjust the flow rate and the pressure of the hydraulic fluid that is supplied to the hydraulic actuator 27 mounted on the attachment 11. The AUX volume switch 34c includes an operation actuator such as a slider, a dial, or a push button that is operated by the operator or the like with a hand, and a displacement sensor that detects a displacement of the operation actuator.

When the AUX volume switch 34c is operated, a detection signal corresponding to the operation (displacement) is output from the displacement sensor, and the AUX manual operator 34 outputs an operation signal (electric signal) corresponding to the detection signal of the displacement sensor to the controller 30. The controller 30 is configured or programmed to detect an operation amount (displacement) of the AUX volume switch 34c based on the operation signal output from the AUX manual operator 34, determine an input current value that is input to the AUX solenoid control valve 65A or 65B based on the operation amount, and input the input current value to one of the AUX solenoid control valves 65A and 65B. Thus, the opening of the AUX solenoid control valve 65A or 65B is set and adjusted, the pilot pressure acting on the AUX control valve 60C from the AUX solenoid control valve 65A or 65B is changed, the opening of the AUX control valve 60C is also set and adjusted, and the flow rate and the pressure of the hydraulic fluid that is supplied from the AUX control valve 60C to the hydraulic actuator 27 are also set and adjusted.

The rotation speed sensor 36 detects the actual rotation speed of the prime mover 6. The controller 30 is configured or programmed to control the driving of the prime mover 6 so that the actual rotation speed of the prime mover 6 meets the target rotation speed input by the accelerator 33. The temperature sensor 37 detects the temperature of the hydraulic fluid. The rotation speed sensor 36 is an example of a rotation speed detector, and the temperature sensor 37 is an example of a temperature detector.

The AUX pressure sensors 38a and 38b are connected to the fluid passages 64a and 64b illustrated in FIG. 1, respectively, and detect the pressures of the hydraulic fluid acting on the AUX couplers 25a and 25b from the AUX control valve 60C, that is, the pressure of the hydraulic fluid that is supplied to the hydraulic actuator 27 of the attachment 11. The controller 30 is configured or programmed to detect the supply states such as the supply/non-supply, the flow rate, and the pressure of the hydraulic fluid to the hydraulic actuator 27 based on the pressure of the hydraulic fluid detected by the AUX pressure sensor 38a or 38b. Then, the controller 30 adjusts the openings of the AUX control valve 60C and the AUX solenoid control valve 65A or 65B based on the detected supply states of the hydraulic fluid, and determines whether the hydraulic actuator 27 and the attachment 11 are in an operating state or a stopped state. The AUX pressure sensors 38a and 38b are examples of a pressure detector.

Examples of the attachment 11 include an attachment 11 on which an electronic device is mounted and an attachment 11 on which an electronic device is not mounted. The attachment 11 on which the electronic device is mounted is provided with a connector 49. By connecting an electric harness to the connector 49 and the AUX connector 39 of the working machine 1, the electronic device of the attachment 11 and the controller 30 are electrically connected to each other, and an electric signal and information can be input/output between the electronic device and the controller 30. The AUX connector 39 is a connection device to electrically connect the attachment 11 to the working machine 1.

The electronic device mounted on the attachment 11 includes an arithmetic processor 47 and a pressure sensor 48. The arithmetic processor 47 includes a CPU, a memory, and the like. The arithmetic processor 47 transmits attachment information relating to the attachment 11 on which the arithmetic processor 47 is mounted to the controller 30 via the connector 49, the electric harness, and the AUX connector 39. The attachment information transmitted by the arithmetic processor 47 includes at least any identification information on the ID, the model number, the name, and the like of the attachment 11. The AUX connector 39 is an example of an input interface (input device, second input interface) to input the attachment information from the arithmetic processor 47.

The pressure sensor 48 detects the pressure of the hydraulic fluid that is supplied from the working machine I to the hydraulic actuator 27. In addition, a pressure sensor that detects the pressure of the hydraulic fluid that returns from the hydraulic actuator 27 to the working machine I may be provided in the attachment 11. Detection signals of the pressure sensor 48 and the like are input to the controller 30 via the connector 49, the electric harness, and the AUX connector 39. The controller 30 may detect the supply states such as the supply/non-supply, the flow rate, and the pressure of the hydraulic fluid to the hydraulic actuator 27 based on the pressures of the hydraulic fluid detected by the pressure sensor 48 and the like. Also, the controller 30 may adjust the openings of the AUX control valve 60C and the AUX solenoid control valve 65A or 65B based on the detected supply states of the hydraulic fluid, and may determine whether the hydraulic actuator 27 and the attachment 11 are in the operating state or in the stopped state. The pressure sensor 48 is an example of a pressure detector.

When attachment information is input from the arithmetic processor 47 or the user interface 32 as described above, the controller 30 identifies (recognizes) the attachment 11 attached to the working machine I based on the input attachment information. At this time, the controller 30 may read other information relating to the attachment 11 corresponding to the input attachment information from the memory 31 and identify the attachment 11 based on the read information. Then, the controller 30 is configured or programmed to control the flow rate and the pressure of the hydraulic fluid that is supplied from the AUX coupler 25 to the hydraulic actuator 27 of the attachment 11 in accordance with the identified attachment 11. To execute the control, the memory 31 stores control data corresponding to the attachment 11 usable in the working machine 1.

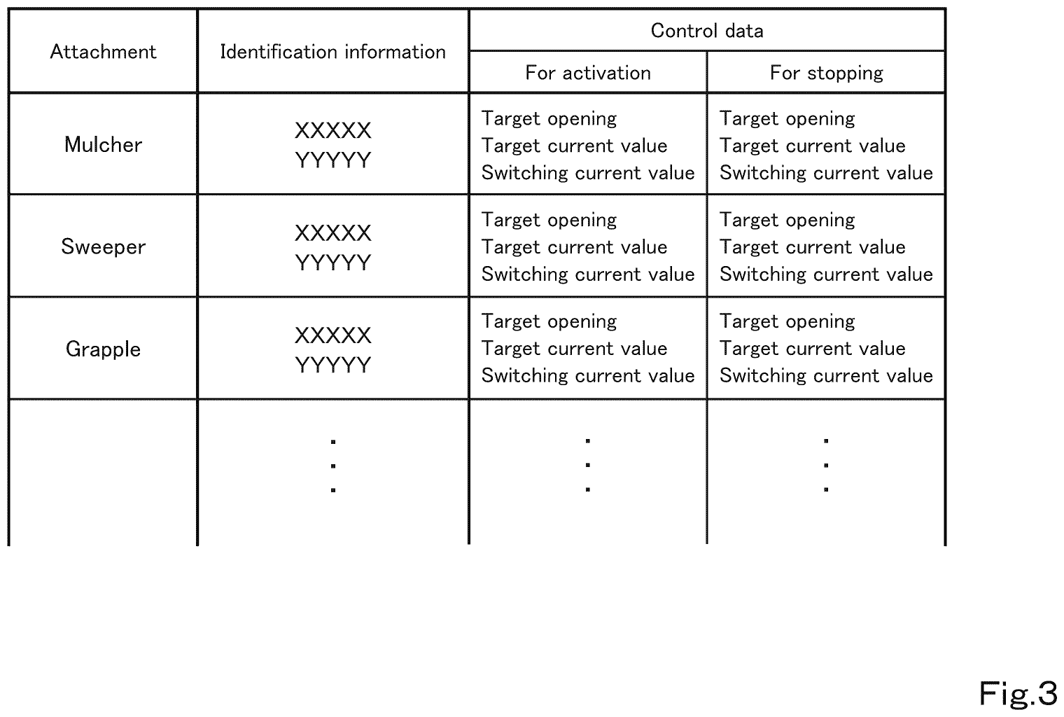

FIG. 3 is a table presenting an example of control data for attachments 11. Specifically, FIG. 3 presents the names of attachments 11 usable in the working machine 1, identification information other than the names of the attachments 11, and control data for the attachments 11 in a table format. The information and the control data are stored in the memory 31 in association with each attachment 11. Also, the control data is set based on data obtained such that the usable attachment 11 is attached to the working machine 1 and a test is performed before the user uses the working machine 1.

The identification information of FIG. 3 includes at least one of the ID, the model number, the serial number, and the like of the attachment 11. The control data is data to control the AUX solenoid control valve 65A or 65B to adjust the flow rate and the pressure of the hydraulic fluid that is supplied to the hydraulic actuator 27 of the attachment 11. The control data includes a target opening, a target current value (second current value), and a switching current value (first current value) of the AUX solenoid control valve 65A or 65B for use in activating the hydraulic actuator 27 and the attachment 11. Furthermore, the control data includes a target opening, a target current value (fourth current value), and a switching current value (third current value) of the AUX solenoid control valve 65A or 65B for use in stopping the hydraulic actuator 27 and the attachment 11.

The target openings are openings to be attained of the first AUX solenoid control valve 65A and the second AUX solenoid control valve 65B. The supply direction of the hydraulic fluid that is supplied from the AUX control valve 60C of FIG. 1 to the hydraulic actuator 27 via the fluid passage 64 and the AUX coupler 25 at the time of activating the attachment 11 is set for each attachment 11. Thus, at the time of activating the attachment 11, the target opening of a non-actuated AUX solenoid control valve, which is an AUX solenoid control valve not to be actuated of the first AUX solenoid control valve 65A and the second AUX solenoid control valve 65B, is 0 (zero), and the target opening of an actuated AUX solenoid control valve, which is an AUX control valve to be actuated, is a value larger than 0. The target openings of the first AUX solenoid control valve 65A and the second AUX solenoid control valve 65B at the time of stopping the attachment 11 are both 0.

The target current values are target current values that are input to the first AUX solenoid control valve 65A and the second AUX solenoid control valve 65B to make the first AUX solenoid control valve 65A and the second AUX solenoid control valve 65B meet the target openings. The target current values correspond to the target openings. At the time of activating the attachment 11, the target current value of the non-actuated AUX solenoid control valve having the target opening of 0% (zero percent) of the first AUX solenoid control valve 65A and the second AUX solenoid control valve 65B is 0 [A] (zero ampere), and the target current value (second current value) of the actuated AUX solenoid control valve having the target opening of a value larger than 0% is a value larger than 0 [A]. Alternatively, the target current value of the actuated AUX solenoid control valve may be the maximum value in a current range that can be set. The target current values (fourth current values) of the first AUX solenoid control valve 65A and the second AUX solenoid control valve 65B at the time of stopping the attachment 11 are both 0 [A].

The switching current value is a switching point (inflection point) at which an amount of current change per unit time when the input current value that is input to the actuated AUX solenoid control valve of the first AUX solenoid control valve 65A and the second AUX solenoid control valve 65B is changed to the target current value, is switched (changed). More specifically, the switching current value is a current value for switching the input current value to the actuated AUX solenoid control valve from step input to ramp input, or from ramp input to step input.

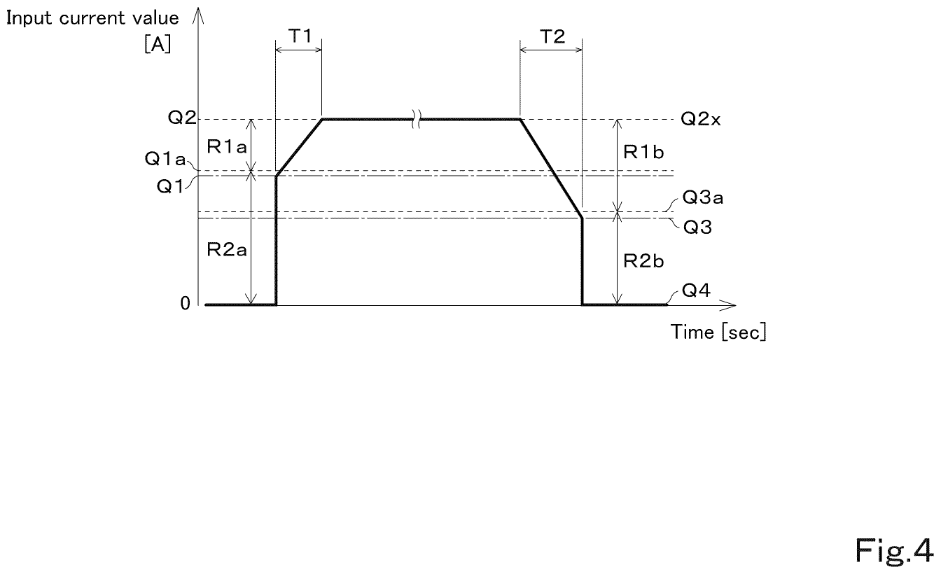

FIG. 4 is a graph presenting an example of a change in the input current value to the AUX solenoid control valve 65A or 65B at the time of activating or stopping the attachment 11 on which the hydraulic actuator 27 is mounted. To activate the attachment 11 attached to the working machine 1 from the stopped state, the input current value to the actuated AUX solenoid control valve of the first AUX solenoid control valve 65A and the second AUX solenoid control valve 65B is increased from 0 A. Accordingly, for example, as indicated by a solid line in a left portion of FIG. 4, the actuated AUX solenoid control valve and the AUX control valve 60C are opened and the hydraulic fluid is supplied to the hydraulic actuator 27 before the input current value reaches a target current value (second current value) Q2. Therefore, the hydraulic actuator 27 and the attachment 11 start moving (are activated).

To activate the attachment 11 and/or the like (and the hydraulic actuator 27) in a stable predetermined state, the target current value Q2 is set to a value higher than an activation point Q1a that is an input current value at which the attachment 11 starts moving (is activated).

A switching current value (first current value) Q1 for use in activating the attachment 11 is set to a relatively high current value within a current range (second current range for activation) R2a (0 [A] or more and less than the activation point Q1a, 0≤R2a<Q1a) in which the attachment 11 does not operate. More specifically, the switching current value Q1 is set to a value lower than the activation point Q1a by a first predetermined value. That is, the switching current value Q1 is set to a current value corresponding to a value immediately before the attachment 11 starts moving (immediately before the attachment 11 is activated). The difference (first predetermined value) between the switching current value Q1 and the activation point Q1a is set to be smaller than the difference between the activation point Q1a and the target current value Q2.

The input current value to the actuated AUX solenoid control valve is input in a step manner from 0 [A] to the switching current value Q1, and is input in a ramp manner from the switching current value Q1 to the target current value Q2. Accordingly, the input current value to the actuated AUX solenoid control valve increases quickly to the switching current value Q1, and gradually increases from the switching current value Q1 to the target current value Q2.

That is, the input current value to the actuated AUX solenoid control valve increases quickly in a range of 0 [A] or more and the switching current value Q1 or less, which is a major portion of the current range R2a in which the attachment 11 does not operate, and the input current value to the actuated AUX solenoid control valve gradually increases in a current range (first current range for activation) R1a (the activation point Q1a or more and the target current value Q2 or less, Q1a≤R1a≤Q2) in which the attachment 11 operates. Also, an amount of current change per unit time until an input current value to the actuated AUX solenoid control valve reaches the target current value Q2 from the switching current value Q1 is less than an amount of current change per unit time until the input current value reaches the switching current value Q1.

When the input current value to the actuated AUX solenoid control valve is decreased to a target current value (fourth current value; 0 [A]) Q4 to stop the attachment 11 attached to the working machine 1 from a driven state, for example, as indicated by a solid line in a right portion of FIG. 4, the openings of the actuated AUX solenoid control valve and the AUX control valve 60C decrease before the input current value reaches the target current value Q4, and the supply amount of the hydraulic fluid to the hydraulic actuator 27 decreases. Therefore, the attachment 11 and the like stop moving (stop). In this way, a stop point Q3a that is an input current value at which the attachment 11 stops moving (stops) is a value higher than the target current value Q4 for stopping (completely stopping) the attachment 11 in a stable predetermined state.

A switching current value (third current value) Q3 for use in stopping the attachment 11 is set to a relatively high current value within a current range (second current range for stopping) R2b (the stopping point Q3a or less and the target current value Q4 or more, Q4≤R2b≤Q3a) in which the attachment 11 does not operate. More specifically, the switching current value Q3 is set to a value lower than the stop point Q3a by a second predetermined value. That is, the switching current value Q3 is set to a current value corresponding to a state immediately after the attachment 11 stops moving (immediately after the attachment 11 stops). The difference (second predetermined value) between the switching current value Q3 and the stop point Q3a is set to be smaller than the difference between the stop point Q3a and the target current value Q4.

Also, since the stop point Q3a is a value lower than the activation point Q1a, the switching current value Q3 for stopping is set to a value lower than the switching current value Q1 for activation. Also, the switching current values Q1 and Q3 are set to values lower than the target current value Q2 for activation and higher than the target current value Q4 for stopping.

The input current value to the actuated AUX solenoid control valve is input in a ramp manner from a drive current value Q2x when the attachment 11 is driven to the switching current value Q3, and is input in a step manner from the switching current value Q3 to the target current value Q4. Accordingly, the input current value to the actuated AUX solenoid control valve gradually decreases to the switching current value Q3, and decreases quickly from the switching current value Q3 to the target current value Q4.

That is, in a current range (first current range for stopping) R1b in which the attachment 11 operates (the drive current value Q2x or less and more than the stop point Q3a, Q3a<R1b≤Q2x), the input current value to the actuated AUX solenoid control valve gradually decreases, and in the current range R2b in which the attachment 11 does not operate, the input current value to the actuated AUX solenoid control valve decreases quickly. Also, an amount of current change per unit time until an input current value to the actuated AUX solenoid control valve reaches the switching current value Q3 is less than an amount of current change per unit time until the input current value reaches the target current value Q4 from the switching current value Q3.

In activating or stopping the attachment 11 attached to the working machine 1, the controller 30 changes the input current value to the actuated AUX solenoid control valve 65A or 65B to the target current value Q2 or Q4, and sets the opening of the actuated AUX solenoid control valve 65A or 65B to the target opening based on the control data corresponding to the attachment 11. Accordingly, the position of the AUX control valve 60C of FIG. 1 is switched, the hydraulic fluid flows into or stops flowing into the hydraulic actuator 27, and the hydraulic actuator 27 and the attachment 11 activate or stop.

Also, in activating or stopping the attachment 11, the controller 30 changes the input current value to the actuated AUX solenoid control valve 65A or 65B to the target current value Q2 or Q4, changes the input method of the input current value to one of step input and ramp input, and also changes the amount of current change per unit time between before and after the input current value reaches the switching current value Q1 or Q3. Also, the controller 30 gradually changes the input current value to the actuated AUX solenoid control valve 65A or 65B in the current range R1a or R1b in which the attachment 11 operates.

In the example presented in FIG. 4, the drive current value Q2x is the same value as the target current value Q2 for activation, but the drive current value Q2x may be a value different from the target current value Q2. The drive current value Q2x can be changed by the operation of the AUX volume switch 34c. For example, in driving the attachment 11 that has been activated, when the operator (user) operates the AUX volume switch 34c, the controller 30 detects an operation amount of the AUX volume switch 34c based on an operation signal output from the AUX manual operator 34 in accordance with the operation of the AUX volume switch 34c, and determines the drive current value Q2x based on the operation amount. Accordingly, the drive current value Q2x is set to a value different from the target current value Q2 corresponding to the attachment 11.

Then, the controller 30 inputs the drive current value Q2x determined in accordance with the operation of the AUX volume switch 34c as described above to the actuated AUX solenoid control valve 65A or 65B. Accordingly, the input current value to the actuated AUX solenoid control valve 65A or 65B is changed, the openings of the actuated AUX solenoid control valve 65A or 65B and the AUX control valve 60C are changed, the flow rate and the pressure of the hydraulic fluid that is supplied from the AUX control valve 60C to the hydraulic actuator 27 are also changed, and the driven states of the hydraulic actuator 27 and the attachment 11 are changed.

Also, thereafter, in stopping the attachment 11, the controller 30 gradually reduces the input current value to the actuated AUX solenoid control valve 65A or 65B from the drive current value Q2x different from the target current value Q2 to the third current value Q3 (ramp input), and further decreases the input current value to the actuated AUX solenoid control valve 65A or 65B quickly from the third current value Q3 to the fourth current value Q4 (step input).

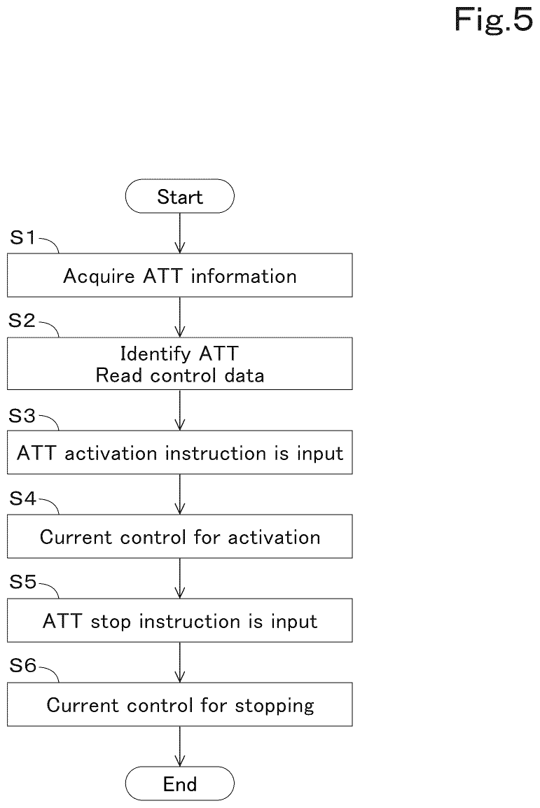

FIG. 5 is a flowchart presenting an example of attachment use processing. When the attachment 11 on which the hydraulic actuator 27 is mounted is used in the working machine 1, the controller 30 executes attachment use processing in accordance with a software program stored in the memory 31. In FIG. 5, the attachment 11 is denoted by “ATT” for convenience.

In a case where the attachment 11 on which the hydraulic actuator 27 is mounted is used in the working machine 1, the worker attaches the attachment 11 to the working machine 1 via the hitch 24 (FIG. 1), and connects the external fluid passages 26a and 26b to the coupler of the attachment 11 and the AUX coupler 25. Also, in a case where the electronic device is mounted on the attachment 11, the worker connects the electric harness to the connector 49 and the AUX connector 39 (FIG. 2) of the attachment 11. Then, when the operator of the working machine 1 performs a turn-on operation on the AUX mode switch 34a, the controller 30 detects the turn-on operation, shifts to the AUX mode, and acquires attachment information from at least one of the arithmetic processor 47 of the attachment 11 and the user interface 32 (S1 of FIG. 5).

In a case where the arithmetic processor 47 is mounted on the attachment 11 attached to the working machine 1, attachment information relating to the attachment 11 is input from the arithmetic processor 47 via the AUX connector 39 or the like, and therefore the controller 30 acquires the attachment information (S1).

In contrast, in a case where the arithmetic processor 47 is not mounted on the attachment 11 attached to the working machine 1, attachment information is not input from the AUX connector 39. As a countermeasure, for example, when a predetermined time elapses without attachment information being input from the AUX connector 39 after the turn-on operation is performed on the AUX mode switch 34a, the controller 30 causes the user interface 32 to display an input screen for inputting attachment information. Then, when the operator operates the user interface 32 to input attachment information (icon, name, or model number) on the attachment 11 attached to the working machine 1 to the input screen, the controller 30 acquires the input attachment information (S1).

As another example, the controller 30 may cause the user interface 32 to display the input screen regardless of whether attachment information is input from the arithmetic processor 47. Then, in a case where attachment information is input from each of the arithmetic processor 47 and the user interface 32, if the two pieces of input attachment information indicate the identical attachment 11, the controller 30 may acquire (use) at least one of the two pieces of input attachment information as attachment information on the attachment 11 attached to the working machine 1.

In contrast, if the two pieces of attachment information from the arithmetic processor 47 and from the user interface 32 do not indicate the identical attachment 11, the controller 30 may output a message for confirming the attached attachment 11 through the user interface 32 without acquiring the two pieces of input attachment information as attachment information on the attachment 11 attached to the working machine 1. Then, the controller 30 may wait for new attachment information to be input from one of the AUX connector 39 and the user interface 32. Alternatively, in a case where attachment information is input from one of the AUX connector 39 and the user interface 32, the controller 30 may acquire the input attachment information.

Alternatively, only one of the input configuration of attachment information through the user interface 32 and the input configuration of attachment information from the AUX connector 39 may be mounted on the hydraulic system 100. Alternatively, the controller 30 may acquire attachment information by a procedure and a method other than the above.

When acquiring attachment information (S1 of FIG. 5), the controller 30 identifies the attachment 11 attached to the working machine 1 based on the attachment information, and reads control data (FIG. 3) corresponding to the identified attachment 11 from the memory 31 (S2). At this time, the controller 30 may read information corresponding to the acquired attachment information from the memory 31 and identify the attachment 11 based on the read information. Alternatively, the controller 30 may specify identification information such as the model number of the attachment 11 corresponding to the acquired attachment information and read control data corresponding to the specified identification information from the memory 31.

When the operator performs an activation operation on the AUX operation switch 34b to activate the attachment 11 in the stopped state, an activation instruction for the attachment 11 is input from the AUX manual operator 34 to the controller 30 (S3). In response to this, the controller 30 executes activation current control based on the control data read from the memory 31 (S4).

In the activation current control, the controller 30 first determines the actuated AUX solenoid control valve to be actuated in activating the attachment 11 of the first AUX solenoid control valve 65A and the second AUX solenoid control valve 65B, and determines the target current value Q2 and the switching current value Q1 based on the control data read from the memory 31.

At this time, as presented in FIG. 4, the controller 30 determines the target current value Q2 to be a value higher than the activation point Q1a at which the attachment 11 starts moving. Also, the controller 30 determines the switching current value Q1 to be a relatively high current value within the current range R2a in which the attachment 11 does not operate, which is a current value smaller than the activation point Q1a by the first predetermined value. Further, the controller 30 determines the switching current value Q1 to be a value higher than the target current value Q4 (0 [A]) for use in stopping the attachment 11.

Then, as presented in FIG. 4, the controller 30 inputs the switching current value Q1 in a step manner as an input current value to the actuated AUX solenoid control valve to increase the input current value quickly (instantaneously) from 0 [A] to the switching current value Q1. Subsequently, the controller 30 inputs an input current value to the actuated AUX solenoid control valve in a ramp manner from the switching current value Q1 to the target current value Q2 based on a predetermined ramp function to gradually increase the input current value from the switching current value Q1 to the target current value Q2 over a predetermined time T1. At this time, the controller 30 limits the input current value so that the amount of current change per unit time of the input current value does not exceed the slope of the predetermined ramp function. That is, the controller 30 gradually increases the input current value to the actuated AUX solenoid control valve in the current range R1a in which the attachment 11 operates.

Accordingly, until immediately before the attachment 11 starts moving, the supply amount of the hydraulic fluid from the AUX control valve 60C to the hydraulic actuator 27 increases quickly, and the supply pressure of the hydraulic fluid increases quickly. Also, from immediately before the attachment 11 starts moving, the supply amount of the hydraulic fluid from the AUX control valve 60C to the hydraulic actuator 27 gradually increases, and the supply pressure of the hydraulic fluid gradually increases. Then, when the input current value to the actuated AUX solenoid control valve has reached the target current value Q2, the hydraulic actuator 27 and the attachment 11 are brought into a stable activated state.

Thereafter, when the operator performs a stop operation on the AUX operation switch 34b to stop the attachment 11 in the driven state, a stop instruction for the attachment 11 is input from the AUX manual operator 34 to the controller 30 (S5 of FIG. 5). In response to this, the controller 30 executes stop current control based on the control data read from the memory 31 (S6).

In the stop current control, the controller 30 first determines the actuated AUX solenoid control valve to be actuated in stopping the attachment 11 of the first AUX solenoid control valve 65A and the second AUX solenoid control valve 65B, and determines the target current value Q4 and the switching current value Q3 based on the control data read from the memory 31. At this time, the controller 30 determines the target current value Q4 to be 0 [A] as presented in FIG. 4. Also, the controller 30 determines the switching current value Q3 to be a relatively high current value within the current range R2b in which the attachment 11 does not operate, which is a current value smaller than the stop point Q3a by the second predetermined value.

Then, as presented in FIG. 4, the controller 30 inputs an input current value to the actuated AUX solenoid control valve in a ramp manner from the drive current value Q2x to the switching current value Q3 based on a predetermined ramp function to gradually decrease the input current value from the drive current value Q2x to the switching current value Q3 for a predetermined time T2. At this time, the controller 30 limits the input current value so that the amount of current change per unit time of the input current value does not exceed the slope of the predetermined ramp function. Subsequently, the controller 30 inputs the target current value Q4 (0 [A]) as an input current value to the actuated AUX solenoid control valve in a step manner to decrease the input current value quickly (instantaneously) from the switching current value Q3 to the target current value Q4.

Accordingly, until immediately after the attachment 11 stops moving, the supply amount of the hydraulic fluid from the AUX control valve 60C to the hydraulic actuator 27 gradually decreases, and the supply pressure of the hydraulic fluid gradually decreases. Also, immediately after the attachment 11 stops moving, the supply amount of the hydraulic fluid from the AUX control valve 60C to the hydraulic actuator 27 decreases quickly, and the supply pressure of the hydraulic fluid decreases quickly. Then, when the input current value to the actuated AUX solenoid control valve has reached the target current value Q4, the hydraulic actuator 27 and the attachment 11 are brought into a stable stopped state.

As described above, the controller 30 determines the target current value Q2 or Q4 and the switching current value Q1 or Q3 for the actuated AUX solenoid control valve 65A or 65B for use in activating or stopping the attachment 11 based on the input attachment information. Then, in changing the input current value to the actuated AUX solenoid control valve 65A or 65B to the target current value Q2 or Q4, the controller 30 changes the amount of current change per unit time or the like of the input current value between before and after the input current value reaches the switching current value Q1 or Q3. Therefore, a sudden flowing or a sudden stop of flowing of the hydraulic fluid to the hydraulic actuator 27 of the attachment 11 is prevented or reduced.

The ramp functions used by the controller 30 in the activation current control and the stop current control are linear functions, but the input current value to the actuated AUX solenoid control valve may be gradually changed by using a quadratic function in at least one of the activation current control and the stop current control.

When the type of the attachment 11 is different, the type and the number of hydraulic actuators 27 mounted on the attachment 11 are also different. Therefore, at least one of the target current value Q2, the switching current value Q1 or Q3, the drive current value Q2x, and the change time (predetermined time) T1 or T2 of the input current value of the actuated AUX solenoid control valve 65A or 65B included in the control data is different.

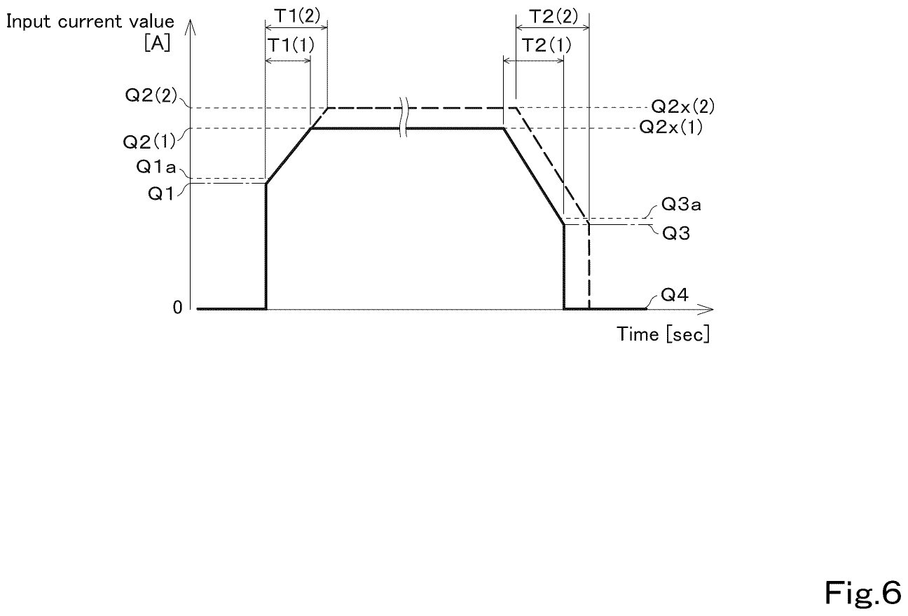

For example, as presented in FIG. 6, in a case where target current values Q2(1) and Q2(2) for activation are different between a first attachment 11 and a second attachment 11, the change state of the input current value to the actuated AUX solenoid control valve 65A or 65B is different between when the controller 30 executes the activation current control (S4) and the stop current control (S6) of FIG. 5 based on attachment information or the like (control data) on the first attachment 11 and when the controller 30 executes the activation current control and the stop current control based on attachment information or the like on the second attachment 11. In FIG. 6, the input current value to the actuated AUX solenoid control valve 65A or 65B in a case where the first attachment 11 is connected to the working machine 1 is indicated by a thick solid line, and the input current value to the actuated AUX solenoid control valve 65A or 65B in a case where the second attachment 11 is connected to the working machine 1 is indicated by a thick broken line.

As presented in FIG. 6, in a case where the target current value Q2(1) of the first attachment 11 is lower than the target current value Q2(2) of the second attachment 11, a change time T1(1) until the input current value reaches the target current value Q2(1) is shorter than a change time T1(2) until the input current value reaches the target current value Q2(2). Also, a change time T2(1) until the input current value reaches the target current value Q4 for stopping from a drive current value Q2x(1) of the first attachment 11 is shorter than a change time T2(2) until the input current value reaches the target current value Q4 from a drive current value Q2x(2) of the second attachment 11. In this way, the controller 30 makes the change times T1(1), T1(2), T2(1), and T2(2) of the input current value to the actuated AUX solenoid control valve 65A or 65B different based on the attachment information on the attachment 11.

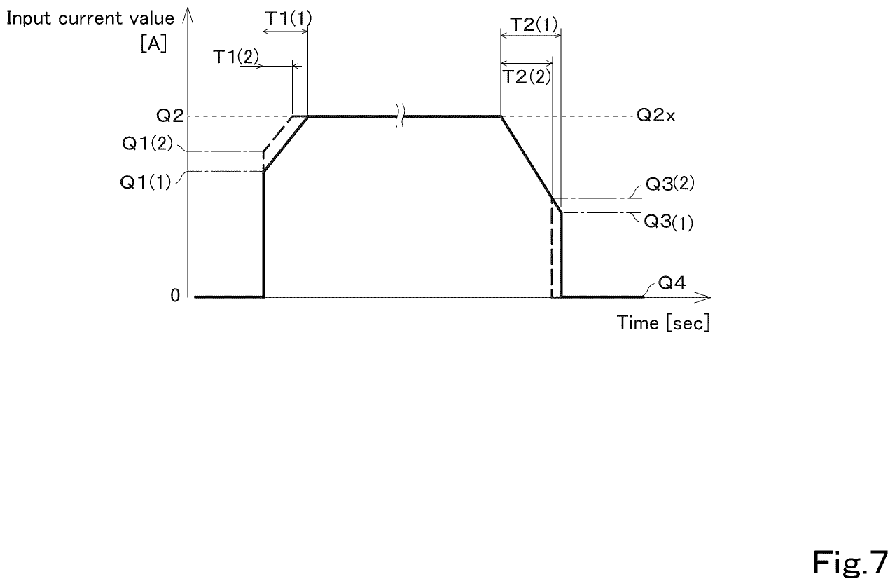

Also, for example, as presented in FIG. 7, in a case where switching current values Q1(1) and Q3(1) of the first attachment 11 are different from switching current values Q1(2) and Q3(2) of the second attachment 11, the change state of the input current value to the actuated AUX solenoid control valve 65A or 65B is different between when the controller 30 executes the activation current control and the stop current control based on the attachment information on the first attachment 11 and when the controller 30 executes the activation current control and the stop current control based on the attachment information on the second attachment 11.

As presented in FIG. 7, in a case where the switching current value Q1(1) for use in activating the first attachment 11 is lower than the switching current value Q1(2) for use in activating the second attachment 11, a change time T1(1) taken for the input current value for use in activating the first attachment 11 to reach the target current value Q2 is longer than a change time T1(2) taken for the input current value for use in activating the second attachment 11 to reach the target current value Q2.

Also, in a case where the switching current value Q3(1) for use in stopping the first attachment 11 is lower than the switching current value Q3(2) for use in stopping the second attachment 11, a change time T2(1) taken for the input current value for use in stopping the first attachment 11 to reach the target current value Q4 is longer than a change time T2(2) taken for the input current value for use in stopping the second attachment 11 to reach the target current value Q4. In this way, the controller 30 makes the change times T1(1), T1(2), T2(1), and T2(2) of the input current value to the actuated AUX solenoid control valve 65A or 65B different based on the attachment information on the attachment 11.

Also, the controller 30 may make the slopes of the ramp functions used in the activation current control and the stop current control different depending on the type of the hydraulic actuator 27 mounted on the attachment 11. The slopes of the ramp functions each correspond to the amount of current change per unit time when the input current value to the actuated AUX solenoid control valve 65A or 65B gradually changes.

For example, in an attachment 11 with a rotary motion hydraulic actuator 27 such as a hydraulic motor, a high surge pressure is more likely to be generated at the time of activation and at the time of stopping as compared with an attachment 11 with a linear motion hydraulic actuator 27 such as a hydraulic cylinder. Also, the attachment 11 on which the linear motion hydraulic actuator 27 is mounted is required to have a higher responsiveness as compared with the attachment 11 on which the rotary motion hydraulic actuator 27 is mounted.

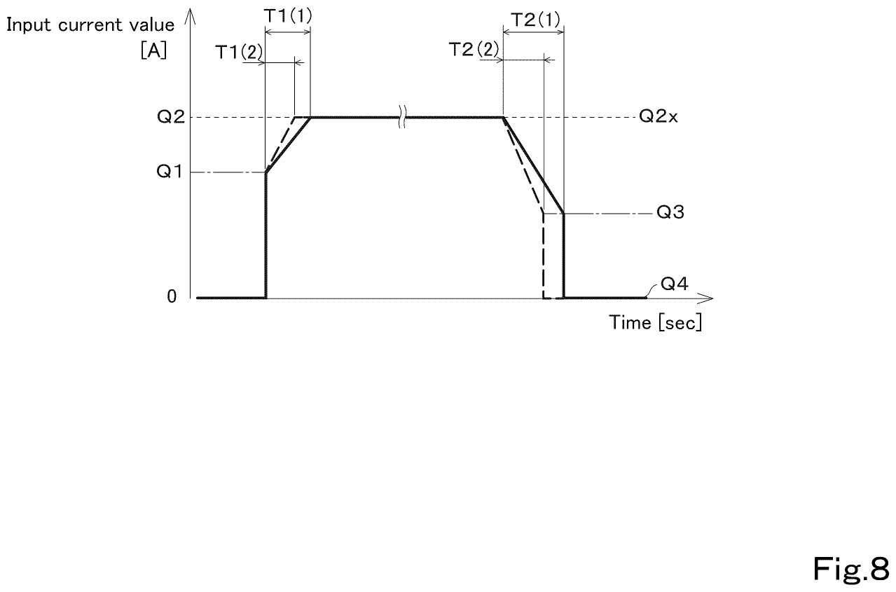

For example, the controller 30 determines the type of the attachment 11 attached to the working machine 1 based on the input attachment information. Then, in a case where the controller 30 determines that the attached attachment 11 is the attachment 11 on which the rotary motion hydraulic actuator 27 is mounted, the controller 30 uses ramp functions having relatively gentle slopes, for example, as indicated by a thick solid line in FIG. 8, in the activation current control and the stop current control. Also, in a case where the controller 30 determines that the attached attachment 11 is the attachment 11 on which the linear motion hydraulic actuator 27 is mounted, the controller 30 uses ramp functions having relatively steep slopes, for example, as indicated by a thick broken line in FIG. 8, in the activation current control and the stop current control.

That is, in the case where the attachment 11 determined based on the attachment information is the attachment on which the linear motion hydraulic actuator 27 is mounted, the controller 30 increases the absolute value of the slopes of the ramp functions used in the activation current control and the stop current control, as compared with the case of the attachment on which the rotary motion hydraulic actuator 27 is mounted.

Also, as the absolute value of the slopes of the ramp functions increases, the amount of current change per unit time when the input current value to the actuated AUX solenoid control valve 65A or 65B gradually changes increases, and the change time (see T1(1), T1(2), T2(1), T2(2) of FIG. 8) taken for the input current value to reach the target current value Q2 or Q4 decreases. Thus, the controller 30 changes the slopes of the ramp functions used in the activation current control and the stop current control based on the attachment information to change the amount of current change per unit time and the change time of the input current value to the actuated AUX solenoid control valve 65A or 65B.

Specifically, for example, in the case where the attachment 11 determined based on the attachment information is the attachment 11 with the linear motion hydraulic actuator 27, the controller 30 increases the absolute value of the slopes of the ramp functions to increase the amount of current change per unit time of the input current value to the actuated AUX solenoid control valve 65A or 65B and decreases the change time, as compared with the case of the attachment 11 with the rotary motion hydraulic actuator 27. The slopes of the ramp functions may be set for each attachment 11 and included in the control data.

In the working machine 1, the rotation speed of the prime mover (engine) 6 is decreased, and work is performed by the working device 4 and the attachment 11 in some cases. However, when the rotation speed of the prime mover 6 decreases, the flow rate and the pressure of the hydraulic fluid delivered from the main pump P2 are decreased, and the flow rate and the pressure of the hydraulic fluid that is supplied from the AUX coupler 25 to the hydraulic actuator 27 of the attachment 11 are also reduced. Therefore, the responsiveness at the time of activating or stopping the hydraulic actuator 27 and the attachment 11 is deteriorated. To address this, the controller 30 may be configured or programmed to, in activating or stopping the attachment 11, change the slope of the ramp function for use in inputting the input current value to the actuated AUX solenoid control valve 65A or 65B in a ramp manner in accordance with the rotation speed of the prime mover 6 detected by the rotation speed sensor 36 (FIG. 2).

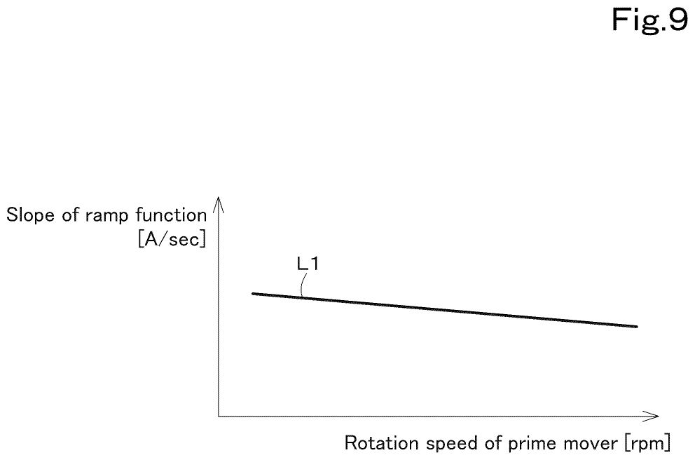

FIG. 9 is a graph presenting the relationship between the rotation speed of the prime mover 6 and the absolute value of the slope of the ramp function. A control line L1 presented in FIG. 9 indicates that the absolute value of the slope of the ramp function increases as the rotation speed of the prime mover 6 decreases. Data such as an arithmetic expression or a table indicating the control line L1 is stored in the memory 31 (FIG. 2).

For example, in the activation current control (S4) of FIG. 5, the controller 30 determines the actuated AUX solenoid control valve 65A or 65B, the target current value Q2, and the switching current value Q1, and applies the rotation speed of the prime mover 6 detected by the rotation speed sensor 36 to the control line L1 to determine the slope of the corresponding ramp function, thus determining the ramp function. Also, in the stop current control (S6) of FIG. 5, the controller 30 determines the actuated AUX solenoid control valve 65A or 65B, the target current value Q4, and the switching current value Q3, and applies the rotation speed of the prime mover 6 detected by the rotation speed sensor 36 to the control line L1 to determine the slope of the corresponding ramp function, thus defining the ramp function.

Alternatively, during the execution of the activation current control or the stop current control, after the determination of the slope of the ramp function corresponding to the rotation speed of the prime mover 6, in a case where the accelerator 33 has been operated and the rotation speed of the prime mover 6 has been changed, the controller 30 may change the slope of the ramp function in accordance with the changed rotation speed of the prime mover 6.

According to the above, as the rotation speed of the prime mover 6 decreases, the absolute value of the slope of the ramp function increases, and the change variation per unit time when the input current value to the actuated AUX solenoid control valve 65A or 65B gradually changes increases. Then, the change time until the input current value to the actuated AUX solenoid control valve 65A or 65B reaches the target current value Q2 or Q4 decreases, and the responsiveness of the activation and stop of the attachment 11 is improved. Also, as the rotation speed of the prime mover 6 increases, the absolute value of the slope of the ramp function decreases, and the amount of current change per unit time of the input current value to the actuated AUX solenoid control valve 65A or 65B decreases. Then, the change time of the input current value to the actuated AUX solenoid control valve 65A or 65B increases, and an impact at the time of activating and stopping the attachment 11 is prevented or reduced.

Also, in a case where the working machine 1 is in a low temperature environment, the temperature of the hydraulic fluid is low, the viscosity is high, and the hydraulic fluid is less likely to flow from the AUX coupler 25 to the hydraulic actuator 27 of the attachment 11. Therefore, the responsiveness at the time of activating or stopping the hydraulic actuator 27 and the attachment 11 is low. To address this, the controller 30 may be configured or programmed to, in activating or stopping the attachment 11, change the slope of the ramp function in accordance with the temperature of the hydraulic fluid detected by the temperature sensor 37 (FIG. 2).

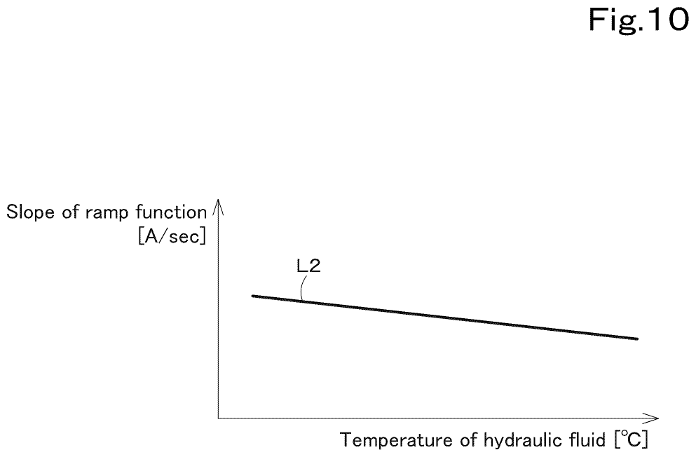

FIG. 10 is a graph presenting the relationship between the temperature of the hydraulic fluid of the working machine 1 and the absolute value of the slope of the ramp function. A control line L2 presented in FIG. 10 indicates that the absolute value of the slope of the ramp function increases as the temperature of the hydraulic fluid decreases. Data such as an arithmetic expression or a table indicating the control line L2 is stored in the memory 31.

For example, in the activation current control, the controller 30 determines the actuated AUX solenoid control valve 65A or 65B, the target current value Q2, and the switching current value Q1, and applies the temperature of the hydraulic fluid detected by the temperature sensor 37 to the control line L2 to determine the slope of the corresponding ramp function, thus determining the ramp function. Also, in the stop current control, the controller 30 determines the actuated AUX solenoid control valve 65A or 65B, the target current value Q4, and the switching current value Q3, and applies the temperature of the hydraulic fluid detected by the temperature sensor 37 to the control line L2 to determine the slope of the corresponding ramp function, thus determining the ramp function.

According to the above, as the temperature of the hydraulic fluid decreases, the absolute value of the slope of the ramp function increases, and the change variation per unit time when the input current value to the actuated AUX solenoid control valve 65A or 65B gradually changes increases. Then, the change time until the input current value to the actuated AUX solenoid control valve 65A or 65B reaches the target current value Q2 or Q4 decreases, and the responsiveness of the activation and stop of the attachment 11 is improved. Also, as the temperature of the hydraulic fluid increases, the absolute value of the slope of the ramp function decreases, and the amount of current change per unit time of the input current value to the actuated AUX solenoid control valve 65A or 65B decreases. Then, the change time of the input current value to the actuated AUX solenoid control valve 65A or 65B increases, and an impact at the time of activating and stopping the attachment 11 is prevented or reduced.

As described above, the controller 30 may determine the target current values Q2 and Q4 and the switching current values Q1 and Q3 for each attachment 11 based on the attachment information, and may determine the slope of the ramp function in accordance with at least one of the rotation speed of the prime mover 6 and the temperature of the hydraulic fluid. Alternatively, the controller 30 may execute at least one of the processing of determining the current values Q1 to Q4 based on the attachment information, the processing of determining the ramp function based on the rotation speed of the prime mover 6, and the processing of determining the ramp function based on the temperature of the hydraulic fluid.

In a case where the processing of determining the current values Q1 to Q4 based on the attachment information is omitted, the current values Q1 to Q4 may be set to fixed values common to all target attachments 11 on which hydraulic actuators 27 are mounted and that are usable in the working machine 1, and stored in the memory 31. Also in this case, the target current value Q2 for activation is set to an input current value of the actuated AUX solenoid control valve 65A or 65B corresponding to the maximum flow rate or a predetermined flow rate of the hydraulic fluid that can be supplied from the AUX control valve 60C to the hydraulic actuator 27 of the attachment 11 via the AUX coupler 25. The target current value Q4 for stopping is set to 0 [A]. The switching current values Q1 and Q3 are set to relatively high current values in the current range of the actuated AUX solenoid control valve 65A or 65B in which all the target attachments 11 do not operate.

Alternatively, the target current values Q2 and Q4 may be fixed values common to all the target attachments 11, and the controller 30 may determine the switching current values Q1 and Q3 based on the attachment information.

Alternatively, for example, when the controller 30 has shifted to the AUX mode, the controller 30 may actuate the AUX control valve 60C and the AUX solenoid control valve 65A or 65B as preprocessing (preparatory processing), and determine the switching current values Q1 and Q3 based on the pressure of the hydraulic fluid detected by at least one of the AUX pressure sensors 38a and 38b and the pressure sensor 48 (FIG. 2).

Specifically, for example, in the state in which the attachment 11 attached to the working machine 1 and the hydraulic actuator 27 are stopped, the controller 30 increases the input current value to one of the first AUX solenoid control valve 65A and the second AUX solenoid control valve 65B by a predetermined value each through step input to supply the hydraulic fluid from the AUX control valve 60C to the hydraulic actuator 27 via the AUX coupler 25, and detects the input current value corresponding to the situation when the attachment 11 has started moving based on the pressure of the hydraulic fluid detected by at least one of the AUX pressure sensors 38a and 38b and the pressure sensor 48. Then, the controller 30 determines a value obtained by subtracting a predetermined value from the detected input current value as the switching current value Q1 for activation.

Also, for example, in the state in which the attachment 11 and the hydraulic actuator 27 are driven, the controller 30 decreases the input current value to one of the first AUX solenoid control valve 65A and the second AUX solenoid control valve 65B through ramp input to decrease the supply amount of the hydraulic fluid that is supplied from the AUX control valve 60C to the hydraulic actuator 27 via the AUX coupler 25, and detects the input current value corresponding to the situation when the attachment 11 has stopped moving based on the pressure of the hydraulic fluid detected by at least one of the AUX pressure sensors 38a and 38b and the pressure sensor 48. Then, the controller 30 determines a value obtained by subtracting a predetermined value from the detected input current value as the switching current value Q3 for stopping.

In the above-described example embodiment, the controller 30 determines the target current value Q2 for use in activating the attachment 11 based on the attachment information. However, the controller 30 may determine or change the target current value Q2 in accordance with the operation of the AUX volume switch 34c. Specifically, for example, when the operator operates the AUX volume switch 34c from the neutral position (non-operation position) in activating the attachment 11, an operation signal corresponding to the operation is output from the AUX manual operator 34. The controller 30 detects the operation amount of the AUX volume switch 34c based on the operation signal output from the AUX manual operator 34, and determines the target current value Q2 based on the operation amount.

Then, the controller 30 inputs the switching current value Q1 in a step manner as an input current value to the actuated AUX solenoid control valve, and increases the input current value quickly from 0 [A] to the switching current value Q1. Subsequently, the controller 30 gradually increases the input current value to the actuated AUX solenoid control valve from the switching current value Q1 to the target current value Q2 determined by the operation of the AUX volume switch 34c based on a predetermined ramp function. At this time, the controller 30 limits the input current value so that the amount of current change per unit time of the input current value does not exceed the slope of the predetermined ramp function.

As another example, the controller 30 may change the target current value Q2 based on the operation amount of the AUX volume switch 34c before or while the input current value to the actuated AUX solenoid control valve is increased after the target current value Q2 for use in activating the attachment 11 is once determined based on the attachment information. Also in this case, in activating the attachment 11, the controller 30 gradually increases an input current value to the actuated AUX solenoid control valve from the switching current value Q1 to the changed target current value Q2 based on a predetermined ramp function, and limits the input current value so that the amount of current change per unit time of the input current value does not exceed the slope of the predetermined ramp function.

Alternatively, the controller 30 may change the drive current value Q2x to increase or decrease based on the operation amount of the AUX volume switch 34c while the attachment 11 is driven, and change the input current value to the actuated AUX solenoid control valve to the changed drive current value Q2x based on a predetermined ramp function.

Alternatively, the controller 30 may determine that the activation instruction for the attachment 11 has been input in a case where the AUX volume switch 34c has been operated in a direction away from the neutral position and the target current value Q2 determined based on the operation amount of the AUX volume switch 34c is larger than the switching current value Q1 while the attachment 11 is stopped. Alternatively, the controller 30 may determine that the stop instruction for the attachment 11 has been input in a case where the AUX volume switch 34c has been operated in a direction of returning toward the neutral position and the drive current value Q2x determined based on the operation amount of the AUX volume switch 34c is smaller than the switching current value Q3 while the attachment 11 is driven. In these cases, the AUX operation switch 34b may be omitted.

In the above-described example embodiment, the controller 30 has shifted to the AUX mode when the turn-on operation has been performed on the AUX mode switch 34a. However, instead of this, the controller 30 may automatically shift to the AUX mode when a sensor detects that an external fluid passage 26 such as a hose has been connected to the AUX coupler 25.

In the above-described example embodiment, the attachment information is input from the user interface 32 or the AUX connector 39 as an example, but the attachment information may be input by an input interface other than these. For example, a storage medium such as an IC tag, a beacon, a two-dimensional code, or a three-dimensional code storing attachment information may be attached to the attachment 11, and the working machine 1 may include a reading device (reader) that reads the attachment information from the storage medium.

In the above-described example embodiment, each processing or the like is implemented by a processing circuit (circuitry) including one processor or a plurality of processors and one memory or a plurality of memories, but may be implemented by an integrated circuit or the like in which at least one of various analog circuits and digital circuits is combined instead of or in addition to the processing circuit. Also, the processor may be, without limited to a CPU, any of various processors configured or programmed to control a computer, such as a graphics processing unit (GPU), a digital signal processor (DSP), a field programmable gate array (FPGA), and an application specific integrated circuit (ASIC).

Also, a plurality of physically separated processors may be configured or programmed to execute each processing or the like in cooperation with each other. For example, processors mounted on a plurality of physically separated computers may be configured or programmed to execute each processing or the like in cooperation with each other via a network such as any of a local area network (LAN), a wide area network (WAN), and the Internet. Further, a software program executed by the processor may be installed in the memory from a server or the like via a network, or may be distributed in a state of being stored in a recording medium such as a memory stick or a memory card and installed in the memory of the processing circuit from the recording medium.

Hydraulic systems 100 and working machines 1 of example embodiments described so far include feature(s) described in the following items and achieve the following effect(s).

[Item 1] A hydraulic system 100 including a control valve 65A, 65B (first AUX solenoid control valve 65A, second AUX solenoid control valve 65B) to adjust a flow rate and a pressure of hydraulic fluid supplied to a hydraulic actuator 27 to actuate an attachment 11 attached to a working machine 1, and a controller 30 configured or programmed to control an opening of the control valve 65A, 65B by changing an input current value input to the control valve 65A, 65B, wherein the controller 30 is configured or programmed to, in activating or stopping the attachment 11 by changing the input current value to a target current value Q2, Q4 corresponding to a target opening of the control valve 65A, 65B, gradually change the input current value in a ramp manner in a first current range R1a, R1b in which the attachment 11 is actuated.

With the configuration of the above-described item 1, it is possible, in activating or stopping the attachment 11, to eliminate or reduce the likelihood that hydraulic fluid will suddenly flow into or suddenly stop flowing into the hydraulic actuator 27, and thus possible to eliminate or reduce the likelihood that a large impact (vibration) will be applied to the attachment 11. Furthermore, since the input current value is gradually changed in the first current range R1a, R1b which is a portion of the entire current range instead of in the entire current range over which the input current value of the control valve 65A, 65B is changed, it is possible to eliminate or reduce the likelihood that the time taken for the attachment 11 to be activated or stopped will increase, and possible to eliminate or reduce the likelihood that the responsiveness of activation or stopping will decrease. Thus, it is possible, in activating or stopping the attachment 11 attached to the working machine 1, to eliminate or reduce the likelihood that an impact will occur and responsiveness will decrease.

[Item 2] The hydraulic system 100 according to item 1, wherein the controller 30 is configured or programmed to, in activating the attachment 11, quickly increase the input current value in a step manner to a first current value Q1 within a second current range R2a in which the attachment 11 is not actuated, and gradually increase the input current value in a ramp manner from the first current value Q1 to a second current value Q2 which is the target current value.

With the configuration of the above-described item 2, it is possible, in activating the attachment 11, to more reliably eliminate or reduce the likelihood that hydraulic fluid will suddenly flow into the hydraulic actuator 27, and more reliably eliminate or reduce the likelihood that a large impact will be applied to the attachment 11. It is also possible to eliminate or reduce the likelihood that responsiveness of the activation of the attachment 11 will decrease.

[Item 3] The hydraulic system 100 according to item 2, further including a first input interface (AUX manual operator) 34 to receive input of an instruction relating to actuation of the attachment 11, wherein the controller 30 is configured or programmed to, when an instruction to activate the attachment 11 is input via the first input interface 34, quickly increase the input current value in a step manner to the first current value Q1 and gradually increase the input current value in a ramp manner from the first current value Q1 to the second current value Q2 over a predetermined time period.

With the configuration of the above-described item 3, it is possible, in activating the attachment 11 in response to the input of the instruction to activate the attachment 11 by a user such as an operator of the working machine 1 via the first input interface 34, to more reliably eliminate or reduce the likelihood that an impact will occur and responsiveness will decrease.

[Item 4] The hydraulic system 100 according to item 2 or 3, wherein the controller 30 is configured or programmed to determine the first current value Q1 which is a relatively high value within the second current range R2a.

With the configuration of the above-described item 4, it is possible, in activating the attachment 11, to allow hydraulic fluid to flow into the hydraulic actuator 27 efficiently until immediately before the attachment 11 starts moving (immediately before activation), and then allow hydraulic fluid to gradually flow into the hydraulic actuator 27. This makes it possible to more reliably eliminate or reduce the likelihood that an impact will occur and responsiveness will decrease.

[Item 5] The hydraulic system 100 according to item 3 or 4, wherein the controller 30 is configured or programmed to determine the first current value Q1 which is a value higher than the target current value Q4 for use in stopping the attachment 11.

With the configuration of the above-described item 5, it is possible, in activating the attachment 11, to allow hydraulic fluid to flow efficiently into the hydraulic actuator 27 and then allow hydraulic fluid to gradually flow into the hydraulic actuator 27. This makes it possible to eliminate or reduce the likelihood that an impact will occur and responsiveness will decrease.

[Item 6] The hydraulic system 100 according to any one of items 2 to 5, further including a second input interface 32, 39 (user interface 32, AUX connector 39) to receive input of attachment information relating to the attachment 11 attached to the working machine 1, wherein the controller 30 is configured or programmed to determine the first current value Q1 based on the attachment information input via the second input interface 32, 39.

With the configuration of the above-described item 6, the first current value Q1 suitable for the attachment 11 attached to the working machine I can be set in the hydraulic system 100. It is then possible, in activating the attachment 11, to appropriately eliminate or reduce the likelihood that hydraulic fluid will suddenly flow into the hydraulic actuator 27 and that a large impact will be applied to the attachment 11, and also possible to eliminate or reduce the likelihood that the responsiveness of activation of the attachment 11 will decrease.

[Item 7] The hydraulic system 100 according to item 6, wherein the controller 30 is configured or programmed to determine the second current value Q2 based on the attachment information input via the second input interface 32, 39.

With the configuration of the above-described item 7, it is possible to set an appropriate target current value Q2 for activation suitable for the attachment 11 attached to the working machine 1 in the hydraulic system 100, and possible to stably and appropriately activate and drive the attachment 11.

[Item 8] The hydraulic system 100 according to item 6, further including a manual operator (AUX manual operator 34) including an operation actuator (AUX volume switch 34c) to be operated to set the flow rate and the pressure of hydraulic fluid supplied to the hydraulic actuator 27, wherein the controller 30 is configured or programmed to, in activating the attachment 11, detect an operation amount of the operation actuator 34c based on an operation signal output from the manual operator 34 in accordance with an operation of the operation actuator 34c, and determine the second current value Q2 based on the operation amount.

With the configuration of the above-described item 8, the user is able to, in activating the attachment 11, set the second current value Q2 which is the target current value by operating the operation actuator 34c, thus supplying hydraulic fluid to the hydraulic actuator 27 of the attachment 11 at a desirable flow rate and a desired pressure to control the driving of the attachment 11. Furthermore, even when the second current value Q2 is set by the operation of the operation actuator 34c to a desired value, the controller 30 increases the input current value for the control valve 65A, 65B quickly to the first current value Q1 and then gradually increases the input current value to the desirably set second current value Q2. This makes it possible to eliminate or reduce the likelihood that a large impact will be applied to the attachment 11 and the responsiveness of activation of the attachment 11 will decrease.

[Item 9] The hydraulic system 100 according to item 1, wherein the controller 30 is configured or programmed to, in stopping the attachment 11, gradually reduce the input current value in a ramp manner to a third current value Q3 within a second current range R2b in which the attachment 11 is not actuated, and quickly reduce the input current value in a step manner from the third current value Q3 to a fourth current value Q4 which is the target current value.

With the configuration of the above-described item 9, it is possible, in stopping the attachment 11, to more reliably eliminate or reduce the likelihood that hydraulic fluid will suddenly stop flowing into the hydraulic actuator 27, and possible to more reliably eliminate or reduce the likelihood that a large impact will be applied to the attachment 11. It is also possible to eliminate or reduce the likelihood that the responsiveness in stopping the attachment 11 will decrease.

[Item 10] The hydraulic system 100 according to item 9, further including a first input interface 34 to receive input of an instruction relating to actuation of the attachment 11, wherein the controller 30 is configured or programmed to, when an instruction to stop the attachment 11 is input via the first input interface 34, gradually reduce the input current value in a ramp manner to the third current value Q3 over a predetermined time period and quickly reduce the input current value in a step manner from the third current value Q3 to the fourth current value Q4.

With the configuration of the above-described item 10, it is possible, in stopping the attachment 11 in response to the input of the instruction to stop the attachment 11 by the user via the first input interface 34, to more reliably eliminate or reduce the likelihood that an impact will occur and responsiveness will decrease.

[Item 11] The hydraulic system 100 according to item 9 or 10, wherein the controller 30 is configured or programmed to determine the third current value Q3 which is a relatively high value within the second current range R2b.

With the configuration of the above-described item 11, it is possible, in stopping the attachment 11, to eliminate or reduce the likelihood that hydraulic fluid will suddenly stop flowing into the hydraulic actuator 27 until immediately after the attachment 11 stops moving (immediately after stopping), and then stop the supply of hydraulic fluid to the hydraulic actuator 27 immediately. This makes it possible to more reliably eliminate or reduce the likelihood that an impact will occur and responsiveness will decrease.

[Item 12] The hydraulic system 100 according to any one of items 9 to 11, further including a second input interface 32, 39 to receive input of attachment information relating to the attachment 11 attached to the working machine 1, wherein the controller 30 is configured or programmed to determine the third current value Q3 based on the attachment information input via the second input interface 32, 39.

With the configuration of the above-described item 12, the third current value Q3 suitable for the attachment 11 attached to the working machine I can be set in the hydraulic system 100. It is then possible, in stopping the attachment 11, to appropriately eliminate or reduce the likelihood that hydraulic fluid will suddenly stop flowing into the hydraulic actuator 27 and that a large impact will be applied to the attachment 11, and also possible to eliminate or reduce the likelihood that responsiveness in stopping the attachment 11 will decrease.

[Item 13] The hydraulic system 100 according to item 12, further including a manual operator 34 including an operation actuator 34c to be operated to set the flow rate and the pressure of hydraulic fluid supplied to the hydraulic actuator 27, wherein the controller 30 is configured or programmed to, in driving the attachment 11 which has been activated, detect an operation amount of the operation actuator 34c based on an operation signal output from the manual operator 34 in accordance with an operation of the operation actuator 34c, determine a drive current value Q2x based on the operation amount, and input the drive current value Q2x into the control valve 65A, 65B, and, in stopping the attachment 11, gradually reduce the input current value in a ramp manner from the drive current value Q2x to the third current value Q3.

With the configuration of the above-described item 13, the user is able to, in driving the attachment 11, desirably set the drive current value Q2x which is input to the control valve 65A, 65B by operating the operation actuator 34c, thus supplying hydraulic fluid to the hydraulic actuator 27 of the attachment 11 at a desirable flow rate and a desired pressure to control the driving of the attachment 11. Furthermore, even when the drive current value Q2x is set by the operation of the operation actuator 34c to a desired value, the controller 30, in stopping the attachment 11, gradually reduces the input current value to the control valve 65A, 5B from the drive current value Q2x to the third current value Q3. This makes it possible to eliminate or reduce the likelihood that a large impact will be applied to the attachment 11 and responsiveness in activating the attachment 11 will decrease.

[Item 14] The hydraulic system 100 according to any one of items 1 to 13, further including a second input interface 32, 39 to receive input of attachment information relating to the attachment 11 attached to the working machine 1, wherein the controller 30 is configured or programmed to change at least one of (i) a change time T1, T2 taken for the input current value to reach the target current value Q2, Q4 or (ii) an amount of current change per unit time when the input current value gradually changes in a ramp manner, based on the attachment information input via the second input interface 32, 39.

With the configuration of the above-described item 14, it is possible, in activating or stopping the attachment 11 attached to the working machine 1, to change the input current value for the control valve 65A, 65B to the target current value Q2, Q4 over the change time T1, T2 suitable for the attachment 11, and to gradually change the input current value for the control valve 65A, 65B within the first current range R1a, R1b at a rate of current change per unit time suitable for the attachment 11. This makes it possible to efficiently supply or stop supplying hydraulic fluid to or from the hydraulic actuator 27, and appropriately eliminate or reduce the likelihood that an impact will occur and responsiveness will decrease.

[Item 15] The hydraulic system 100 according to item 14, wherein the controller 30 is configured or programmed to determine a type of the hydraulic actuator 27 based on the attachment information input via the second input interface 32, 39, and change at least one of the change time T1, T2 or the amount of current change per unit time based on the type of the hydraulic actuator 27.

With the configuration of the above-described item 15, it is possible, in activating or stopping the attachment 11, to change the input current value for the control valve 65A or 65B to the target current value Q2, Q4 over the change time T1, T2 suitable for the type of the hydraulic actuator 27, and to gradually change the input current value for the control valve 65A, 65B within the first current range R1a, R1b at a rate of current change per unit time suitable for the type of the hydraulic actuator 27. This makes it possible to more efficiently supply or stop supplying hydraulic fluid to or from the hydraulic actuator 27, and possible to more appropriately eliminate or reduce the likelihood that an impact will occur and responsiveness will decrease.

[Item 16] The hydraulic system 100 according to item 15, wherein the controller 30 is configured or programmed to, in a case that the hydraulic actuator 27 is a linear motion hydraulic actuator, perform at least one of (i) reducing the change time compared to a case where the hydraulic actuator 27 is a rotary motion hydraulic actuator or (ii) increasing the amount of current change per unit time as compared to the case where the hydraulic actuator 27 is a rotary motion hydraulic actuator.

With the configuration of the above-described item 16, in the case where the attachment 11 with a linear motion hydraulic actuator 27 such as a hydraulic cylinder is attached to the working machine 1, the responsiveness of activating or stopping the attachment 11 can be further improved. Furthermore, in the case where the attachment 11 with a rotary motion hydraulic actuator 27 such as a hydraulic motor is attached to the working machine 1, the surge pressure generated when activating or stopping the attachment 11 can be further reduced, and the occurrence of an impact can be more reliably prevented or reduced.

[Item 17] The hydraulic system 100 according to any one of items 1 to 16, further including a prime mover 6, a hydraulic pump P2 to deliver hydraulic fluid using power output from the prime mover 6, and a rotation speed detector (rotation speed sensor) 36 to detect a rotation speed of the prime mover 6, wherein the controller 30 is configured or programmed to, in activating or stopping the attachment 11, change an amount of current change per unit time when the input current value gradually changes in a ramp manner, in accordance with the rotation speed of the prime mover 6 detected by the rotation speed detector 36.

With the configuration of the above-described item 17, it is possible, in activating or stopping the attachment 11, to gradually change the input current value for the control valve 65A, 65B at an efficient rate of current change per unit time suitable for the rotation speed of the prime mover 6. Accordingly, the occurrence of an impact and a decrease in responsiveness can be appropriately prevented or reduced.

[Item 18] The hydraulic system 100 according to item 17, wherein the controller 30 is configured or programmed to increase the amount of current change per unit time as the rotation speed of the prime mover 6 decreases.

With the configuration of the above-described item 18, even when the rotation speed of the prime mover 6 decreases when activating or stopping the attachment 11, the input current value for the control valve 65A, 65B can be gradually changed at an efficient rate of current change per unit time suitable for the rotation speed of the prime mover 6. Accordingly, the occurrence of an impact and a decrease in responsiveness can be prevented or reduced.

[Item 19] The hydraulic system 100 according to any one of items 1 to 18, further including a temperature detector (temperature sensor) 37 to detect a temperature of hydraulic fluid, wherein the controller 30 is configured or programmed to, in activating or stopping the attachment 11, change the amount of current change per unit time when the input current value gradually changes in a ramp manner, in accordance with the temperature of hydraulic fluid detected by the temperature detector 37.

With the configuration of the above-described item 19, it is possible, in activating or stopping the attachment 11, to gradually change the input current value for the control valve 65A, 65B at an efficient rate of current change per unit time suitable for the temperature of the hydraulic fluid. Accordingly, the occurrence of an impact and a decrease in responsiveness can be appropriately prevented or reduced.

[Item 20] The hydraulic system according 100 to item 19, wherein the controller 30 is configured or programmed to increase the amount of current change per unit time as the temperature of the hydraulic fluid decreases.

With the configuration of the above-described item 20, even when the temperature of the hydraulic fluid is low when activating or stopping the attachment 11, the input current value for the control valve 65A, 65B can be gradually changed at a rate of current change per unit time suitable for the temperature of the hydraulic fluid. Accordingly, the occurrence of an impact and a decrease in responsiveness can be prevented or reduced.

[Item 21] A working machine 1 including a linkage (hitch) 24 to link an attachment 11 thereto, and the hydraulic system 100 according to any one of items 1 to 20.

With the configuration of the above-described item 21, the occurrence of an impact and a decrease in responsiveness can be prevented or reduced when activating or stopping the attachment 11 attached to the working machine 1 via the linkage 24.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A hydraulic system comprising:
a control valve to adjust a flow rate and a pressure of hydraulic fluid supplied to a hydraulic actuator to actuate an attachment attached to a working machine; and
a controller configured or programmed to control an opening of the control valve by changing an input current value input to the control valve; wherein
the controller is configured or programmed to, in activating or stopping the attachment by changing the input current value to a target current value corresponding to a target opening of the control valve, gradually change the input current value in a ramp manner in a first current range in which the attachment is actuated.

2. The hydraulic system according to claim 1, wherein the controller is configured or programmed to, in activating the attachment, quickly increase the input current value in a step manner to a first current value within a second current range in which the attachment is not actuated, and gradually increase the input current value in a ramp manner from the first current value to a second current value which is the target current value.

3. The hydraulic system according to claim 2, further comprising:
a first input interface to receive input of an instruction relating to actuation of the attachment; wherein
the controller is configured or programmed to, when an instruction to activate the attachment is input via the first input interface, quickly increase the input current value in a step manner to the first current value and gradually increase the input current value in a ramp manner from the first current value to the second current value over a predetermined time period.

4. The hydraulic system according to claim 2, wherein the controller is configured or programmed to determine the first current value which is a value lower by a first predetermined value than a maximum value of the second current range.

5. The hydraulic system according to claim 3, wherein the controller is configured or programmed to determine the first current value which is a value higher than the target current value for use in stopping the attachment.

6. The hydraulic system according to claim 2, further comprising:
a second input interface to receive input of attachment information relating to the attachment attached to the working machine; wherein
the controller is configured or programmed to determine the first current value based on the attachment information input via the second input interface.

7. The hydraulic system according to claim 6, wherein the controller is configured or programmed to determine the second current value based on the attachment information input via the second input interface.

8. The hydraulic system according to claim 6, further comprising:
a manual operator including an operation actuator to be operated to set the flow rate and the pressure of hydraulic fluid supplied to the hydraulic actuator; wherein
the controller is configured or programmed to, in activating the attachment, detect an operation amount of the operation actuator based on an operation signal output from the manual operator in accordance with an operation of the operation actuator, and determine the second current value based on the operation amount.

9. The hydraulic system according to claim 1, wherein the controller is configured or programmed to, in stopping the attachment, gradually reduce the input current value in a ramp manner to a third current value within a second current range in which the attachment is not actuated, and quickly reduce the input current value in a step manner from the third current value to a fourth current value which is the target current value.

10. The hydraulic system according to claim 9, further comprising:
a first input interface to receive input of an instruction relating to actuation of the attachment; wherein
the controller is configured or programmed to, when an instruction to stop the attachment is input via the first input interface, gradually reduce the input current value in a ramp manner to the third current value over a predetermined time period and quickly reduce the input current value in a step manner from the third current value to the fourth current value.

11. The hydraulic system according to claim 9, wherein the controller is configured or programmed to determine the third current value which is a value lower by a second predetermined value than a maximum value of the second current range.

12. The hydraulic system according to claim 9, further comprising:
a second input interface to receive input of attachment information relating to the attachment attached to the working machine; wherein
the controller is configured or programmed to determine the third current value based on the attachment information input via the second input interface.

13. The hydraulic system according to claim 12, further comprising:
a manual operator including an operation actuator to be operated to set the flow rate and the pressure of hydraulic fluid supplied to the hydraulic actuator; wherein
the controller is configured or programmed to:
in driving the attachment which has been activated, detect an operation amount of the operation actuator based on an operation signal output from the manual operator in accordance with an operation of the operation actuator, determine a drive current value based on the operation amount, and input the drive current value into the control valve; and
in stopping the attachment, gradually reduce the input current value in a ramp manner from the drive current value to the third current value.

14. The hydraulic system according to claim 1, further comprising:
a second input interface to receive input of attachment information relating to the attachment attached to the working machine; wherein
the controller is configured or programmed to change at least one of (i) a change time taken for the input current value to reach the target current value or (ii) an amount of current change per unit time when the input current value gradually changes in a ramp manner, based on the attachment information input via the second input interface.

15. The hydraulic system according to claim 14, wherein the controller is configured or programmed to determine a type of the hydraulic actuator based on the attachment information input via the second input interface, and change at least one of the change time or the amount of current change per unit time based on the type of the hydraulic actuator.

16. The hydraulic system according to claim 15, wherein the controller is configured or programmed to, in a case that the hydraulic actuator is a linear motion hydraulic actuator, perform at least one of (i) reducing the change time compared to a case where the hydraulic actuator is a rotary motion hydraulic actuator or (ii) increasing the amount of current change per unit time as compared to the case where the hydraulic actuator is a rotary motion hydraulic actuator.

17. The hydraulic system according to claim 1, further comprising:
a prime mover;
a hydraulic pump to deliver hydraulic fluid using power output from the prime mover; and
a rotation speed detector to detect a rotation speed of the prime mover; wherein
the controller is configured or programmed to, in activating or stopping the attachment, change an amount of current change per unit time when the input current value gradually changes in a ramp manner, in accordance with the rotation speed of the prime mover detected by the rotation speed detector.

18. The hydraulic system according to claim 17, wherein the controller is configured or programmed to increase the amount of current change per unit time as the rotation speed of the prime mover decreases.

19. The hydraulic system according to claim 1, further comprising:
a temperature detector to detect a temperature of hydraulic fluid; wherein
the controller is configured or programmed to, in activating or stopping the attachment, change an amount of current change per unit time when the input current value gradually changes in a ramp manner, in accordance with the temperature of hydraulic fluid detected by the temperature detector.

20. The hydraulic system according to claim 19, wherein the controller is configured or programmed to increase the amount of current change per unit time as the temperature of the hydraulic fluid decreases.

21. A working machine comprising:
a linkage to link an attachment thereto; and
the hydraulic system according to claim 1.
